(19) United States
(12) Patent Application Publication
(10) Pub. No.: US 2026/0054343 A1
(43) Pub. Date: Feb. 26, 2026

(54) MACHINING-STATE-ESTIMATING DEVICE, AND MACHINING-STATE-ESTIMATING METHOD

(71) Applicant: Panasonic Intellectual Property Management Co., Ltd., Osaka (JP)

(72) Inventors: NAOKI NOJIRI, Osaka (JP); HIDEAKI HAMADA, Hyogo (JP); MITSUO SAITOH, Osaka (JP); SATORU KISHIMOTO, Kyoto (JP)

(21) Appl. No.: 19/372,341

(22) Filed: Oct. 29, 2025

Related U.S. Application Data
(63) Continuation of application No. PCT/JP2024/010957, filed on Mar. 21, 2024.

(30) Foreign Application Priority Data
May 10, 2023 (JP) 2023-078008

(51) Int. Cl. B23Q 17/09; B21D 28/26

(52) U.S. Cl. CPC B23Q 17/099; B21D 28/26; B23Q 17/0966; B23Q 2717/00

(57) ABSTRACT

A machining-state-estimating device includes a storage device and a processor. The storage device stores criterion reference data corresponding to a parameter that defines a machining state of a pressing machine and zone shape information. The zone shape information defines a zone length and a retreating amount. The zone length indicates a length of each of at least one zone representing a punched contour by the pressing machine. The retreating amount indicates a dimensional change of the punched contour from a predetermined position in each of the at least one zone. The processor acquires measurement data indicating a measurement result of a machining load of machining performed by the pressing machine, and generates comprehensive reference data regarding the machining load based on the criterion reference data and the zone shape information. The processor determines a similarity degree that is an index of a degree of similarity between the comprehensive reference data and the measurement data, and estimates a machining state in each of the at least one zone based on the similarity degree determined.

### TECHNICAL FIELD

The present disclosure relates to a machining-state-estimating device and a machining-state-estimating method.

### BACKGROUND ART

PTL 1 discloses a technique of obtaining a determination value by synthesizing a state amount in a normal facility and a state amount in an abnormal facility in a device such as a pressing machine that repeats the same work in a relatively short cycle. The determination device of PTL 1 generates an alarm when a state amount of a target device exceeds the determination value or falls below the determination value.

### CITATION LIST

### Patent Literature

PTL 1: Unexamined Japanese Patent Publication No. H9-120365

### SUMMARY OF THE INVENTION

A machining-state-estimating device according to an aspect of the present disclosure includes a storage device, and a processor. The storage device stores criterion reference data corresponding to a parameter that defines a machining state of a pressing machine, and zone shape information, the zone shape information is information that defines a zone length and a retreating amount, the zone length indicating a length of each of at least one zone representing a punched contour by the pressing machine, the retreating amount indicating a dimensional change of the punched contour from a predetermined position in each of the at least one zone, and the processor is configured to acquire measurement data indicating a measurement result of a machining load of machining performed by the pressing machine, generate comprehensive reference data regarding the machining load based on the criterion reference data and the zone shape information, determine a similarity degree that is an index of a degree of similarity between the comprehensive reference data and the measurement data, and estimate the machining state in each of the at least one zone based on the similarity degree determined.

A machining-state-estimating method according to another aspect of the present disclosure includes acquiring, by a processor, measurement data indicating a measurement result of a machining load of machining performed by a pressing machine, generating, by the processor, comprehensive reference data regarding the machining load based on criterion reference data and zone shape information, the criterion reference data corresponding to a parameter that defines a machining state of the pressing machine, the zone shape information defining a zone length and a retreating amount, the zone length indicating a length of each of at least one zone representing a punched contour by the pressing machine, the retreating amount indicating a dimensional change of the punched contour from a predetermined position in each zone, determining, by the processor, a similarity degree that is an index of a degree of similarity between the comprehensive reference data and the measurement data, and estimating, by the processor, the machining state in each of the at least one zone based on the similarity degree determined.

### BRIEF DESCRIPTION OF THE DRAWINGS

FIG. 1 is a block diagram illustrating a configuration example of a machining-state-estimating device according to a first exemplary embodiment.

FIG. 2 is a schematic sectional view illustrating a pressing machine to which a load sensor and a distance sensor illustrated in FIG. 1 are attached.

FIG. 3 is a schematic graph representing an example of a measured waveform by the load sensor illustrated in FIG. 1.

FIG. 4 is a schematic view illustrating an outline of machining state estimation processing executed by the machining-state-estimating device in FIG. 1.

FIG. 5 is a schematic sectional view for explaining a zone of a punched contour of the pressing machine in FIG. 2.

FIG. 6A is a schematic view illustrating a section of a punch taken along a broken line M1 in FIG. 5.

FIG. 6B is a schematic view illustrating a section of the punch taken along a broken line M2 in FIG. 5.

FIG. 7 is a graph representing a relationship between an actual retreating amount of an edge of the punch and a position of the punched contour in a circumferential direction.

FIG. 8 is a diagram for explaining an example of a retreating amount parameter corresponding to the actual retreating amount in FIG. 7.

FIG. 9 is a table representing an example of state data illustrated in FIG. 1.

FIG. 10A is a graph for explaining synthesis of waveforms in consideration of a retreating amount.

FIG. 10B is a graph for explaining synthesis of waveforms in consideration of the retreating amount.

FIG. 11 is a flowchart illustrating a procedure of machining state estimation processing.

FIG. 12 is a flowchart illustrating normal state estimation processing illustrated in FIG. 11.

FIG. 13 is a flowchart illustrating workpiece thickness estimation processing illustrated in FIG. 12.

FIG. 14 is a flowchart illustrating reference waveform generation processing corresponding to the state data in FIG. 13.

FIG. 15 is a flowchart illustrating reference waveform generation processing corresponding to provisional state data in FIG. 13.

FIG. 16 is a flowchart illustrating punch wear amount estimation processing illustrated in FIG. 12.

FIG. 17 is a flowchart illustrating die wear amount estimation processing illustrated in FIG. 12.

FIG. 18 is a flowchart illustrating chipping estimation processing illustrated in FIG. 12.

FIG. 19 is a flowchart illustrating post-polishing state estimation processing illustrated in FIG. 11.

FIG. 20 is a flowchart illustrating post-polishing clearance estimation processing illustrated in FIG. 19.

FIG. 21 is a flowchart illustrating post-replacement state estimation processing illustrated in FIG. 11.

FIG. 22A is a graph representing a relationship between the actual retreating amount of the edge of the punch and the position of the punched contour in the circumferential direction.

FIG. 22B is a diagram for explaining an example of a retreating amount parameter corresponding to the actual retreating amount in FIG. 22A.

FIG. 22C is a diagram for explaining another example of the retreating amount parameter corresponding to the actual retreating amount in FIG. 22A.

FIG. 23 is a table representing an example of state data according to a second exemplary embodiment.

FIG. 24A is a diagram illustrating a distribution of a retreating amount in a second zone of the state data illustrated in FIG. 23.

FIG. 24B is a diagram illustrating a plurality of zones obtained by subdividing the second zone illustrated in FIG. 23 in accordance with the retreating amount.

FIG. 25A is a graph for explaining synthesis of waveforms in consideration of a retreating amount of a punch according to the second exemplary embodiment.

FIG. 25B is a graph for explaining synthesis of waveforms in consideration of the retreating amount of the punch according to the second exemplary embodiment.

FIG. 26 is a diagram illustrating a retreating amount represented by state data according to a modification of the second exemplary embodiment.

FIG. 27 is a schematic sectional view of a punch of a pressing machine according to a third exemplary embodiment.

FIG. 28 is a sectional view of a section parallel to a ZX plane of the punch of FIG. 27 as viewed in a positive direction of a Y-axis.

FIG. 29 is a graph representing a relationship between an actual retreating amount of an edge of the punch in FIG. 27 and a position of a punched contour in a circumferential direction.

FIG. 30 is data obtained by subdividing the actual retreating amount in FIG. 29.

FIG. 31 is a table representing an example of state data according to the third exemplary embodiment.

FIG. 32A is a graph for explaining synthesis of waveforms in consideration of a retreating amount of the punch according to the third exemplary embodiment.

FIG. 32B is a graph for explaining synthesis of waveforms in consideration of the retreating amount of the punch according to the third exemplary embodiment.

### DESCRIPTION OF EMBODIMENT

### (Knowledge as Basis of Present Disclosure)

The inventors of the present invention have repeatedly conducted studies for accurately estimating a machining state of a pressing machine in press machining, particularly punching, and as a result, have obtained the following findings. Here, the “machining state” refers to at least one of a wear amount of a tool such as a punch or a die, a clearance, a thickness of a workpiece, or a chipping amount.

A load applied to the punch or the workpiece at the time of punching depends on values such as a punch wear amount, a die wear amount, a clearance, a thickness of a workpiece, and a chipping amount.

The punch wear amount and the die wear amount are examples of a punch wear parameter that is an index indicating a degree of wear of the punch and a die wear parameter that is an index indicating a degree of wear of the die. The wear amount of the tool such as the punch wear amount and the die wear amount is represented by, for example, a dimensional change of the tool from a design value. The wear amount of the tool may be represented by a change amount such as a shape change, a volume change, and a mass change. In addition, the wear amount of the tool may be represented by a radius of an arc in a case where the wear is approximated as the arc.

The clearance is a gap between the die and the punch. For example, the clearance is a gap between the die and the punch when a punching hole is formed in the workpiece. The clearance may be represented by a ratio of the gap between the die and the punch and the thickness of the workpiece.

Chipping refers that a part of the tool misses due to collision, fatigue, or the like. A chipping depth and a chipping width represent a depth and a width of the tool missing due to chipping. The chipping depth and the chipping width are examples of parameters representing a depth and a width of a missing part from a punched contour of the tool in a normal state. The chipping depth and the chipping width are represented, for example, by a dimensional change retreated by missing from the design value of the tool. Alternatively, the chipping depth and the chipping width may be represented as a distribution of dimensional changes described above.

The chipping depth is an example of a “retreating amount” of the present disclosure. The retreating amount is represented, for example, by a dimensional change of the contour of the tool from a predetermined criterion position.

Since the load depends on these parameters, it is conceivable to estimate these parameters from a load waveform obtained during machining. For example, when it is determined whether or not chipping occurs in the tool, and the chipping width and the chipping depth can be estimated, in a case where chipping occurs, production can be stopped at a stage at which chipping reaches a predetermined chipping amount, for example, a chipping amount causing abnormality in a product. As a result, it is possible to prevent a situation such as manufacturing a large number of defective products in advance, and it is possible to improve productivity.

In the pressing machine that performs cycle machining, there is an advantage that an estimation result of the machining state for immediately preceding punching is used for the estimation of the machining state. One of the reasons is that values of the clearance, the punch wear amount, the die wear amount, and the like usually do not change greatly from values in the immediately preceding punching.

On the other hand, chipping occurs during one cycle machining. Thus, when chipping occurs, the chipping amount greatly changes from a value in an immediately preceding machining cycle. For example, while the chipping width and the chipping depth are both 0 mm immediately before chipping occurs, the chipping width and the chipping depth are values more than 0 mm in machining immediately after the occurrence.

Based on these findings, the inventors of the present invention have found that the accuracy of the estimation of the parameters is improved by performing the estimation under a condition that the parameter such as the wear amount other than the chipping amount does not greatly change from a value in the immediately preceding machining cycle. On the other hand, the inventors of the present invention have found that the accuracy of the estimation of the chipping amount is improved by performing estimation under a condition that the chipping amount greatly changes from a value in the immediately preceding machining cycle in a case where chipping occurs.

An object of the present disclosure is to provide a machining-state-estimating device and a machining-state-estimating method for estimating a machining state by a pressing machine more accurately than in related art.

Hereinafter, exemplary embodiments of the present disclosure will be described herein in detail with reference to the drawings appropriately. It is noted that a more detailed description than need may be omitted. For example, a detailed description of an already well-known matter and a duplicated description of substantially the same configuration will be omitted in some cases. This is to avoid an unnecessarily redundant description below and to facilitate understanding of a person skilled in the art. Note that, the inventors provide the attached drawings and the following description for those skilled in the art to fully understand the present disclosure, and do not intend that the attached drawings and the following description limit the subject matter described in the scope of claims.

### First Exemplary Embodiment

### 1. Configuration

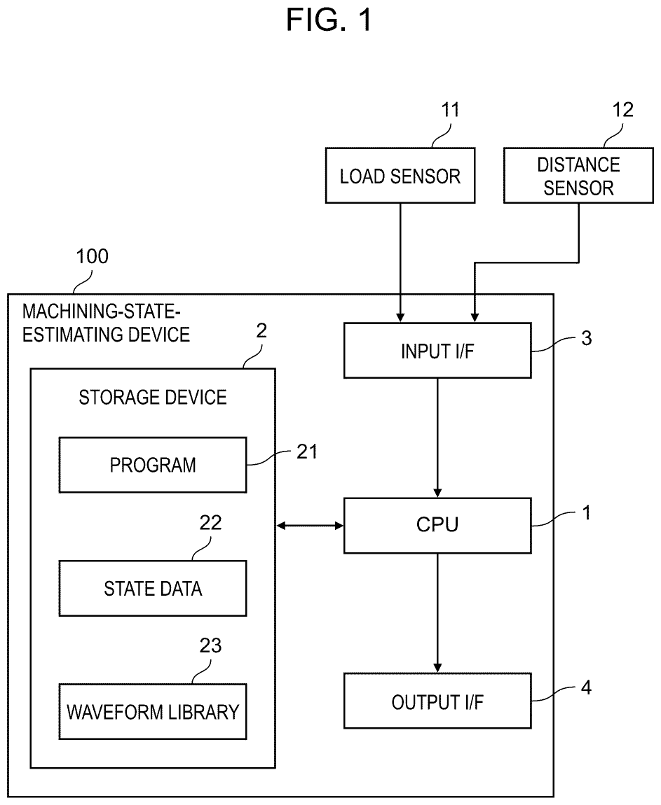

FIG. 1 is a block diagram illustrating a configuration example of machining-state-estimating device 100 according to a first exemplary embodiment of the present disclosure. Machining-state-estimating device 100 includes CPU 1, storage device 2, input interface (I/F) 3, and output interface (I/F) 4.

CPU 1 performs information processing to implement a function of machining-state-estimating device 100 to be described later. Such information processing is implemented, for example, by CPU 1 operating according to a command of program 21 stored in storage device 2. CPU 1 is an example of a processor of the present disclosure. The processor may include an arithmetic circuit that performs an arithmetic operation for information processing, and is not limited to the CPU. For example, the processor may include a circuit such as an MPU, or an FPGA.

Storage device 2 is a recording medium that records various types of information including data such as waveform library 23 and state data 22 to be described later, and program 21 necessary for realizing the function of machining-state-estimating device 100. Storage device 2 is implemented by, for example, a semiconductor storage device such as a flash memory or a solid state drive (SSD), a magnetic storage device such as a hard disk drive (HDD), or other storage media alone or in combination thereof. Storage device 2 may include a volatile memory such as an SRAM or a DRAM.

Input interface 3 is an interface circuit that connects machining-state-estimating device 100 and an external device in order to input information such as detection results by load sensor 11 and distance sensor 12 to machining-state-estimating device 100. Such an external device is, for example, a device such as load sensor 11 or another information processing terminal. Input interface 3 may be a communication circuit that performs data communication according to an existing wired communication standard or wireless communication standard.

Output interface 4 is an interface circuit that connects machining-state-estimating device 100 and an external output device in order to output information from machining-state-estimating device 100. Such an output device is, for example, a display or another information processing terminal. Output interface 4 may be a communication circuit that performs data communication according to an existing wired communication standard or wireless communication standard. Input interface 3 and output interface 4 may be realized by similar hardware.

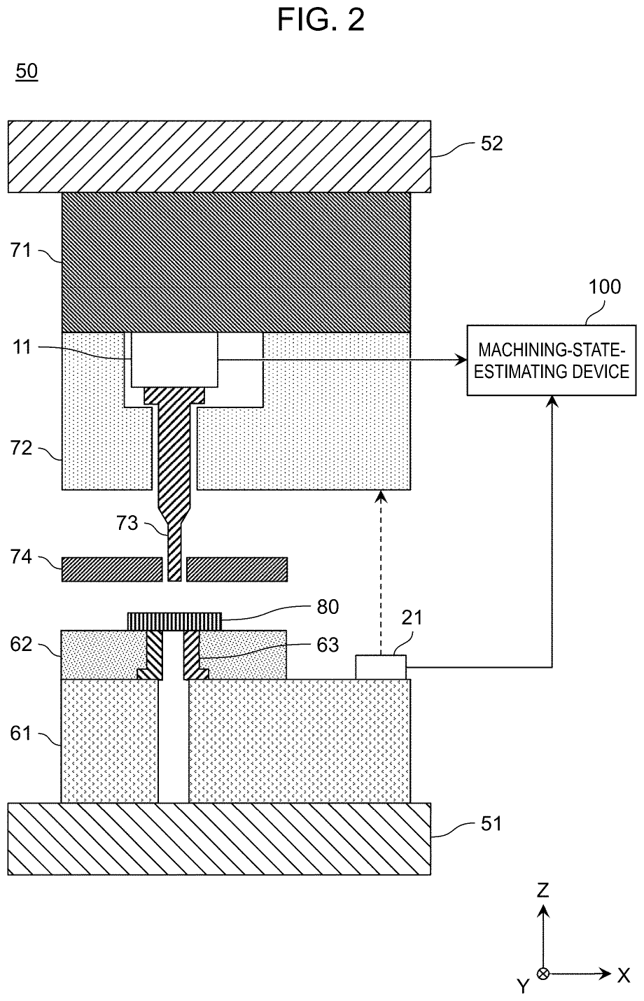

FIG. 2 is a schematic sectional view illustrating pressing machine 50 to which load sensor 11 and distance sensor 12 illustrated in FIG. 1 are attached. In FIG. 2 and a part of subsequent drawings, an X-axis, a Y-axis, and a Z-axis orthogonal to each other are illustrated for the sake of convenience in description. The Z-axis indicates a vertical direction, and an upward orientation is a positive direction.

Pressing machine 50 is an example of a machining machine that performs cycle machining of repeating the same machining. Pressing machine 50 includes bolster 51 and slide 52 that repeatedly performs an up-down cycle motion from a top dead center to a bottom dead center with respect to bolster 51. Die backing plate 61 is attached onto bolster 51, and die plate 62 is attached onto die backing plate 61. Die plate 62 grips die 63.

Punch backing plate 71 is attached to a lower portion of slide 52, and punch plate 72 is attached to a lower portion of punch backing plate 71. Punch plate 72 grips punch 73. Pressing machine 50 further includes stripper plate 74. Stripper plate 74 is attached to a fastener such as a bolt and punch plate 72 or punch backing plate 71 via a positioning guide such as a post (not illustrated), for example. Stripper plate 74 is biased downward by, for example, a compression spring, and has a function of guiding punch 73 such that a position of punch 73 is constant, a function of extracting a material attached to punch 73 after punching workpiece 80, and/or a function of fixing workpiece 80 at the time of punching workpiece 80.

Load sensor 11 is installed, for example, between punch 73 and punch backing plate 71. Load sensor 11 is, for example, a piezoelectric force sensor or an electric force sensor such as a strain gauge-based sensor, and measures a load applied to punch 73 when punch 73 pierces workpiece 80.

Distance sensor 12 is installed, for example, on die backing plate 61. Distance sensor 12 is, for example, an eddy current type gap sensor or a laser displacement meter. Distance sensor 12 measures, for example, a distance from distance sensor 12 to punch plate 72 in a Z direction.

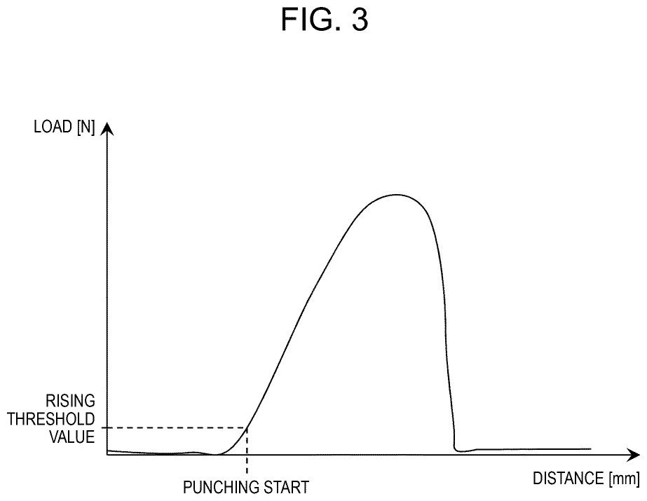

FIG. 3 is a schematic graph representing an example of a measured waveform by load sensor 11. The graph of FIG. 3 represents a measured waveform in a case where chipping does not occur. In the graph of FIG. 3, a horizontal axis represents a distance that punch 73 advances in a negative direction of the Z-axis from an initial state, and a vertical axis represents a load. The graph of FIG. 3 illustrates a waveform of a curve in which a load starts to be applied to workpiece 80, punch 73, and load sensor 11 from a point in time when punch 73 is lowered to come into contact with workpiece 80 in the punching, the load rapidly decreases to almost 0 after workpiece 80 is punched, and an intermediate portion becomes high. A punching start timing of the punching can be measured by using, as a criterion, a distance at which the load exceeds a rising threshold value in the measured waveform, for example. Such a rising threshold value may be determined as an absolute value or may be determined as a ratio of the load to a peak value.

### 2. Operation

### [2-1. Outline of Operation]

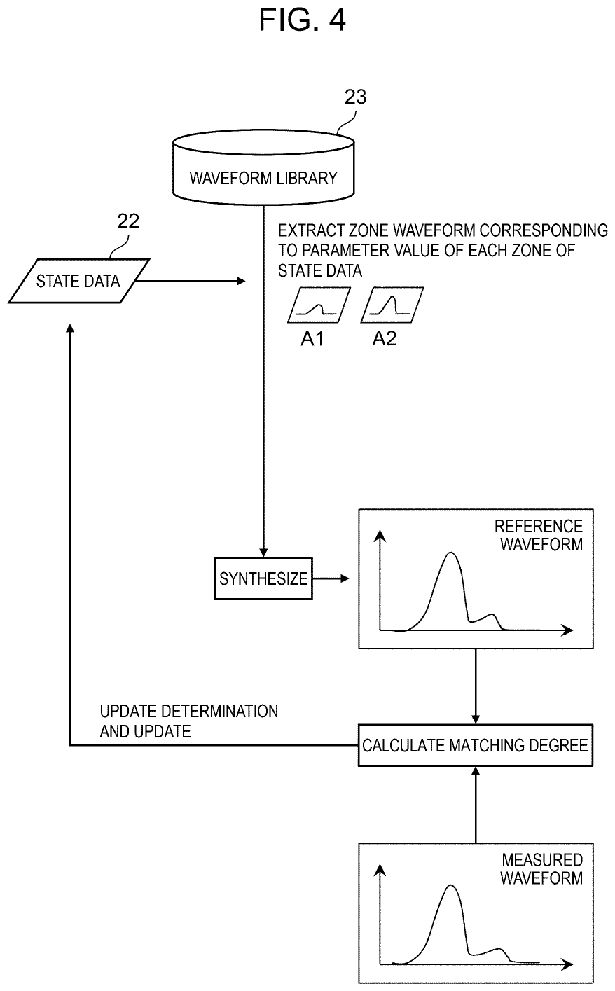

An outline of machining state estimation processing will be described with reference to FIGS. 4 to 10B. FIG. 4 is a schematic view illustrating an outline of machining state estimation processing executed by machining-state-estimating device 100 of FIG. 1.

CPU 1 acquires unit waveforms (hereinafter, may be referred to as “criterion reference data”.) per unit length of a punched contour of pressing machine 50 from waveform library 23, and generates zone waveforms (zone data) corresponding to two zones A1 and A2. CPU 1 synthesizes the zone waveforms in consideration of retreating amounts to generate a reference waveform (hereinafter, may be referred to as “comprehensive reference data”.), and compares the measured waveform with the reference waveform. Since the unit waveform is associated with a parameter indicating at least one of the wear amount of the tool, the clearance, or the workpiece thickness, a parameter of each of the zones A1 and A2 can be estimated by searching for a reference waveform having a high matching degree with the measured waveform.

FIG. 5 is a schematic sectional view for explaining zones A1 and A2 of the punched contour of pressing machine 50. The sectional view of FIG. 5 illustrates only punch 73 and die 63 to facilitate understanding of the description. The sectional view of FIG. 5 illustrates a state where chipping occurs in punch 73. In the example of FIG. 5, a portion missing by chipping is illustrated as region 73C. In addition, in the example of FIG. 5, all edges of the punched contour of punch 73 in design have the same value with respect to the Z-axis. That is, the workpiece is punched at the same height on the Z-axis in design.

In the present exemplary embodiment, a case where chipping occurs in punch 73 will be described, but the present disclosure is not limited thereto, and chipping may occur in die 63 or in both punch 73 and die 63.

The punched contour is a contour of a portion to be punched out of workpiece 80 to be punched by punching by pressing machine 50. Shapes of punch 73 and die 63 are designed such that a desired punched contour can be realized. The punched contour may be a design value of a contour of punch 73 viewed from a punching direction or a design value of a contour of an opening of die 63 viewed from the punching direction.

Zones A1 and A2 of the punched contour are obtained by dividing the punched contour. Where to divide the punched contour is determined by a width of the chipping. In the example of FIG. 5, a punched contour having a round-corner rectangular shape is divided into first zone A1 and second zone A2 with chipping region 73C as a criterion. First zone A1 corresponds to a portion of the punched contour where chipping does not occur. Second zone A2 corresponds to a portion of the punched contour where chipping occurs.

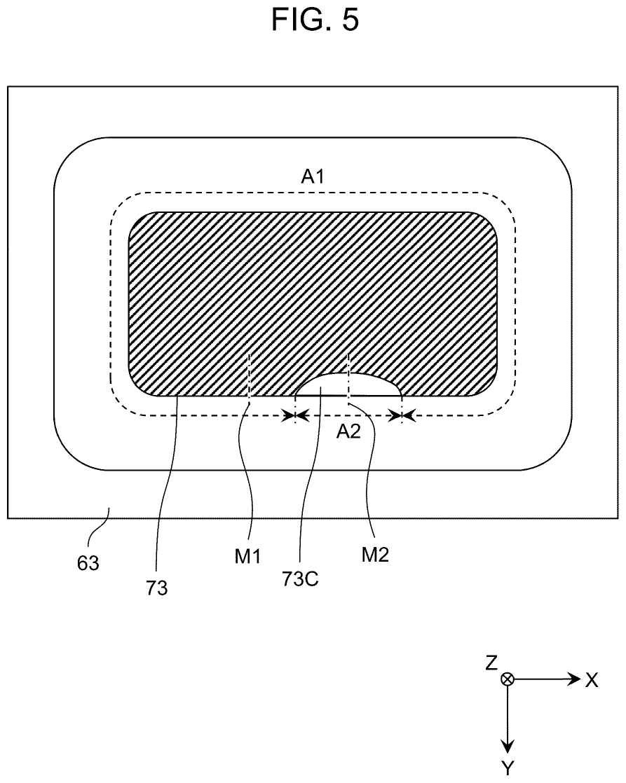

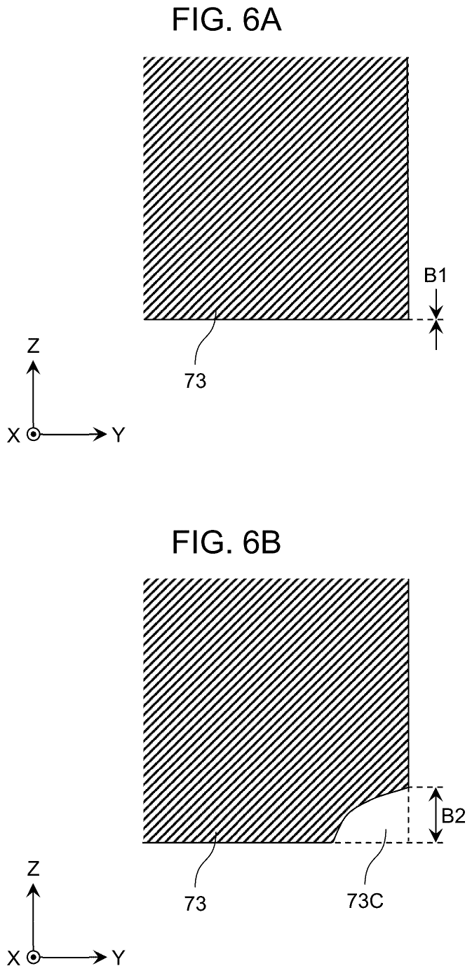

FIG. 6A is a schematic view illustrating a section of punch 73 taken along broken line M1 in FIG. 5. FIG. 6B is a schematic view illustrating a section of punch 73 taken along broken line M2 in FIG. 5. FIG. 6A illustrates a section of the portion where chipping does not occur, and FIG. 6B illustrates a section of the portion where chipping occurs. In the example of FIGS. 6A and 6B, the section is parallel to a YZ plane. In the present exemplary embodiment, as illustrated in FIG. 6A, retreating amount B1 of the portion where chipping of punch 73 does not occur is 0 mm. In contrast, as illustrated in FIG. 6B, retreating amount B2 of the portion where the chipping of punch 73 occurs is not 0 mm but is an amount corresponding to a depth of chipping region 73C.

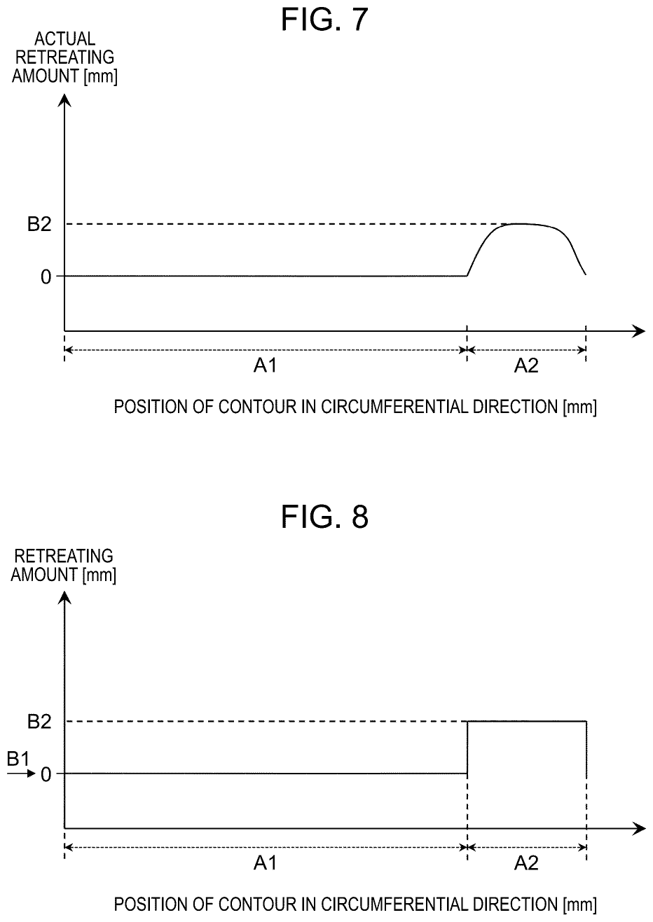

FIG. 7 is a graph representing a relationship between an actual retreating amount of an edge of punch 73 and a position of the punched contour in a circumferential direction. In FIG. 7, it can be seen that the actual retreating amount is 0 mm at a position corresponding to first zone A1 where chipping does not occur and the actual retreating amount is more than 0 mm at a position corresponding to second zone A2 where chipping occurs. In the example of FIG. 7, in second zone A2, the actual retreating amount is not constant, and has a distribution with respect to the position.

FIG. 8 is a diagram for explaining an example of a retreating amount parameter corresponding to the actual retreating amount in FIG. 7. For example, the retreating amount parameter is obtained by modeling the actual retreating amount in FIG. 7. In the present exemplary embodiment, in each zone, the retreating amount is represented as a single parameter constituting a representative value of the actual retreating amount. In the example of FIG. 8, the retreating amount in first zone A1 is represented by B1 (=0), and the retreating amount in second zone A2 is represented by representative value B2 of the actual retreating amount. The representative value is, for example, a maximum value.

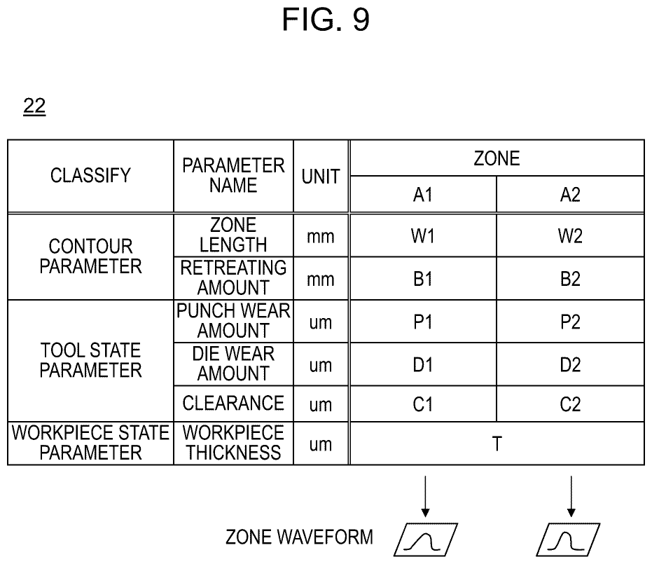

FIG. 9 is a table representing an example of state data 22. State data 22 includes a contour parameter that defines information regarding the punched contour, a tool state parameter that defines a state of the tool, and a workpiece state parameter that defines a state of the workpiece. In the present specification, the tool state parameter and the workpiece state parameter may be collectively referred to as a “state parameter”. In the example of FIG. 9, the contour parameter includes a zone length along the punched contour and a retreating amount. In the example of FIG. 9, the tool state parameter includes a punch wear amount, a die wear amount, and a clearance. In the example of FIG. 9, the workpiece state parameter is a workpiece thickness.

The contour parameter illustrated in FIG. 9 is an example of “zone shape information” of the present disclosure. For the contour parameter, a zone length and a retreating amount in first zone A1 are denoted as W1 and B1, and a zone length and a retreating amount in second zone A2 are denoted as W2 and B2. The zone length of the contour parameter indicates a length of the punched contour in each zone. The retreating amount of the contour parameter indicates a retreating amount (chipping depth) of each zone. Since retreating amounts B1 and B2 and zone lengths W1 and W2 are parameters that characterize the shape of chipping region 73C, these parameters may be referred to as “chipping parameters” or “retreating amount parameters” in the present specification.

For the tool state parameter represented in FIG. 9, a punch wear amount, a die wear amount, and a clearance in first zone A1 are denoted as P1, D1, and C1, and a punch wear amount, a die wear amount, and a clearance in second zone A2 are denoted as P2, D2, and C2.

In the example of FIG. 9, workpiece thickness T is constant over the entire zone. However, the present exemplary embodiment is not limited thereto, and the workpiece thickness may take a different value for every zone similarly to other parameters.

For example, punch wear amounts P1 and P2 can be set to any one of candidate values of 0 μm, 2 μm, 4 μm, 6 μm, 8 μm, 10 μm, and 12 μm. For example, die wear amounts D1 and D2 can be set to any one of candidate values of 0 μm, 2 μm, 4 μm, 6 μm, 8 μm, 10 μm, and 12 μm. For example, clearances C1 and C2 can be set to any one of candidate values of 3 μm, 4 μm, 5 μm, 6 μm, and 7 μm. For example, workpiece thickness T can be set to any one of candidate values of 46 μm, 48 μm, 50 μm, 52 μm, and 54 μm. Note that, the candidate values for the punch wear amount, the die wear amount, the clearance, and the workpiece thickness are not limited thereto, and the number of candidate values is not limited to the above number.

As in the above example, in a case where the number of candidate values for the punch wear amount is 7, the number of candidate values for the die wear amount is 7, the number of candidate values for the clearance is 5, and the number of candidate values for the workpiece thickness is 5, 1225 types of unit waveforms are registered in waveform library 23 in advance. As described above, waveform library 23 is a four-dimensional table in which unit waveforms corresponding to an array of the punch wear amount, the die wear amount, the clearance, and the workpiece thickness are registered.

In waveform library 23, unit waveforms per unit length of the punched contour corresponding to all combinations of the punch wear amount, the die wear amount, the clearance, and the workpiece thickness are registered in advance. The unit length is a predetermined unit length, for example, 1 mm. In the present exemplary embodiment, the unit waveform is a waveform representing a relationship between the distance and the load, similarly to the measured waveform in FIG. 3.

The unit waveform is obtained, for example, by actually measuring a punching load or by multiplying a waveform obtained by simulation by a ratio of a unit length to an overall length of the punched contour. For example, in a case where the unit length is 1 [mm] and the overall length of the punched contour is L [mm], the unit waveform is obtained by actually measuring the punching load or by multiplying the waveform obtained by simulation by 1/L.

In addition, for example, a ratio of each of zone lengths W1 and W2 is adjusted by 1 mm step under a condition that the sum matches overall zone length W that is the overall length of the punched contour. For example, in a case where overall zone length W is 5 mm and retreating amount B1 is fixed to 0, retreating amount B2 can be set by 1 mm step in a range from 0 mm to 5 mm. Note that, a step width of the zone length, a range and a step width of the retreating amount are not limited thereto.

As illustrated in FIGS. 4 and 9, CPU 1 acquires a unit waveform corresponding to a combination of the punch wear amount, the die wear amount, the clearance, and the workpiece thickness of each zone from waveform library 23. Subsequently, CPU 1 generates a zone waveform for every zone by multiplying each unit waveform by the zone length. As illustrated in FIG. 9, CPU 1 generates a reference waveform indicating a load over the overall length of the punched contour by synthesizing the two zone waveforms in consideration of the retreating amount of each zone.

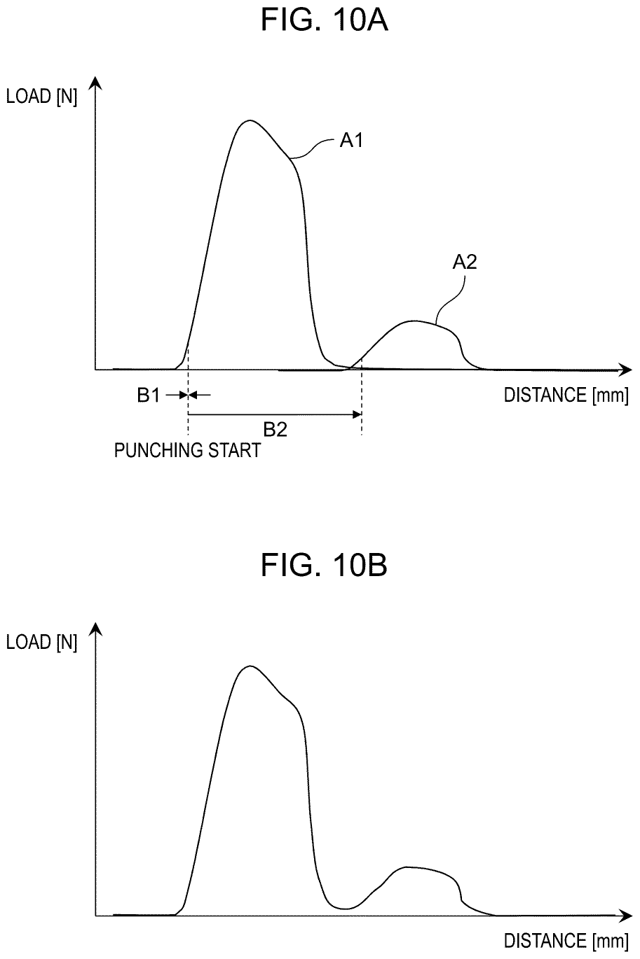

FIGS. 10A and 10B are graphs for explaining synthesis of waveforms in consideration of the retreating amount of punch 73. FIG. 10A illustrates two waveforms corresponding to zones A1 and A2.

In a case where the retreating amount of punch 73 is taken into consideration, the waveform corresponding to each zone is a waveform obtained by adding the retreating amount to the distance with respect to the waveform in a case where the retreating amount is not taken into consideration (the above-described zone waveform). That is, in a case where the retreating amount of punch 73 is taken into consideration, the waveform corresponding to each zone is a waveform obtained by shifting the zone waveform in a distance direction by the retreating amount. The reason why the waveform is shifted in a case where chipping occurs is that a point in time when the retracted (chipped) portion of the tool collides with the workpiece is delayed from a point in time when the portion where the chipping of the tool does not occur collides with the workpiece.

In the example of FIG. 10A, since retreating amount B1 is 0, the waveform corresponding to first zone A1 is the zone waveform itself in a case where the retreating amount is not taken into consideration. The waveform corresponding to second zone A2 is a waveform obtained by shifting the zone waveform in a case where the retreating amount is not taken into consideration in the distance direction by retreating amount B2.

A waveform of FIG. 10B is a synthesized waveform obtained by adding the two waveforms of FIG. 10A.

As illustrated in FIG. 4, CPU 1 searches for a reference waveform having a maximum matching degree with the measured waveform, and estimates a combination of parameters (see FIG. 9) corresponding to a unit waveform of each zone, which is a basis of the searched reference waveform, as an estimated parameter set representing a machining state of the zone.

### [2-2. Flowchart]

### [2-2-1. Overall Flow]

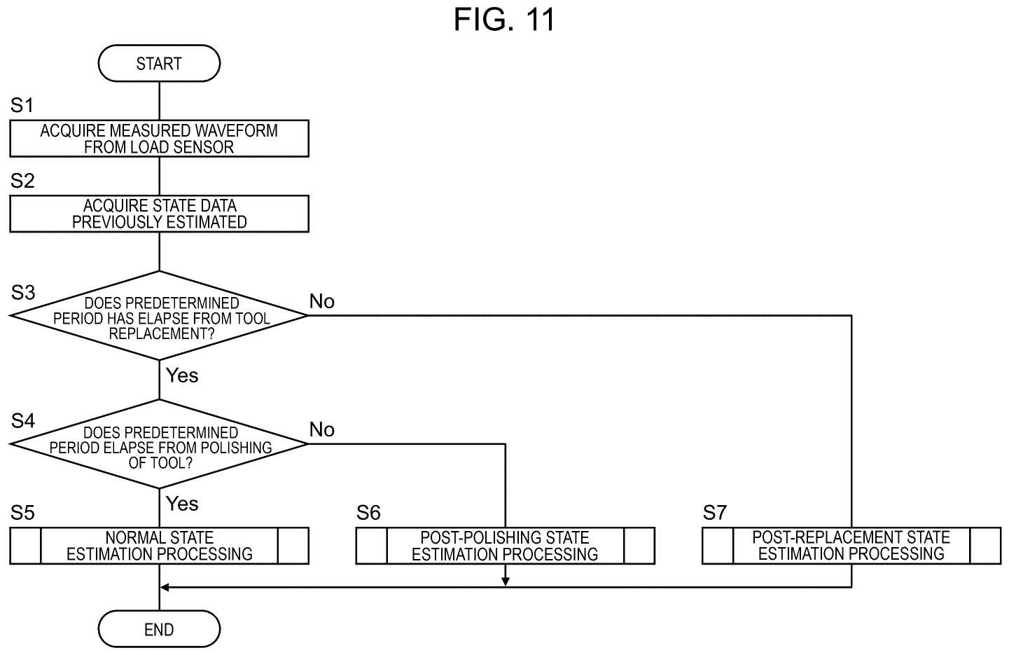

FIG. 11 is a flowchart illustrating a procedure of machining state estimation processing executed by CPU 1 of machining-state-estimating device 100 of FIG. 1.

First, CPU 1 acquires, from load sensor 11, a measured waveform indicating a measurement result of the load applied to load sensor 11 at the time of the press machining by pressing machine 50 (S1). Here, CPU 1 acquires measured waveforms in each machining cycle in time series.

Subsequently, CPU 1 acquires state data 22 indicating the estimated parameter set which is a previous estimation result (S2).

Subsequently, CPU 1 determines whether or not a predetermined period elapses after the replacement of the tool is performed (S3). For example, CPU 1 determines whether or not a predetermined period elapses after a tool replacement signal indicating that the replacement of the tool is performed is received. In a case where the press machining is performed a predetermined number of times or more after the tool replacement signal is received, CPU 1 may determine that the predetermined period elapses. For example, a user presses a tool replacement completion button provided on pressing machine 50, a user interface of machining-state-estimating device 100, or the like, and thus, such a tool replacement signal is transmitted to CPU 1.

In a case where it is determined that the predetermined period elapses after the replacement of the tool is performed (Yes in S3), CPU 1 determines whether or not a predetermined period elapses after the tool is polished (S4). For example, CPU 1 determines whether or not a predetermined period elapses after a die polishing signal indicating that the die is polished and/or a punch polishing signal indicating that the punch is polished is received. In a case where the press machining is performed a predetermined number of times or more after the die polishing signal and/or the punch polishing signal is received, CPU 1 may determine that the predetermined period elapses. For example, the user presses a die polishing completion button and/or a punch polishing completion button provided on pressing machine 50, the user interface of machining-state-estimating device 100, or the like, and thus, such a signal is transmitted to CPU 1.

In a case where it is determined that the predetermined period elapses after the tool is polished (Yes in S4), CPU 1 executes first state estimation processing (hereinafter, referred to as “normal state estimation processing”.) S5. Details of normal state estimation processing S5 will be described later.

In a case where it is determined in step S4 that the predetermined period does not elapse after the tool is polished (No in S4), CPU 1 executes second state estimation processing (hereinafter, referred to as “post-polishing state estimation processing”.) S6. Details of post-polishing state estimation processing S6 will be described later.

In a case where it is determined in step S3 that the predetermined period does not elapse after the replacement of the tool is performed (No in S3), CPU 1 executes third state estimation processing (hereinafter, referred to as “post-replacement state estimation processing”.) S7. Details of post-replacement state estimation processing S7 will be described later. [2-2-2. Normal state estimation processing S5]

### [2-2-2-1. Main Processing]

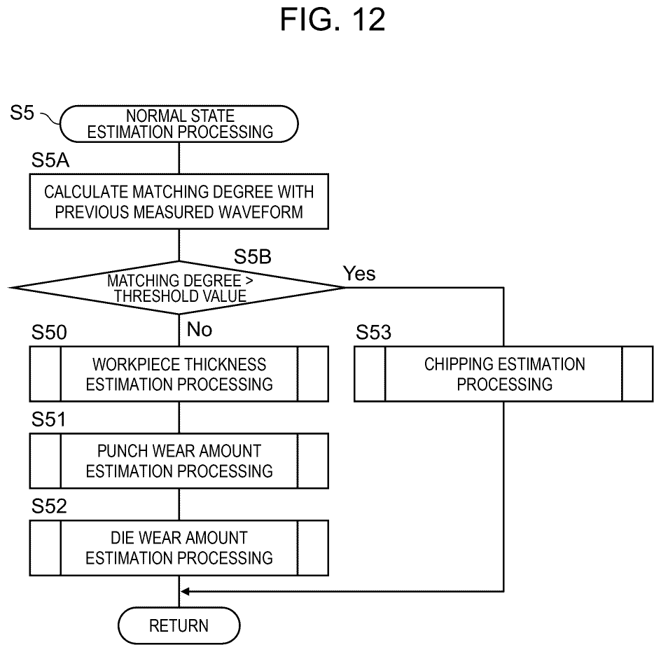

FIG. 12 is a flowchart illustrating normal state estimation processing S5 illustrated in FIG. 11.

In normal state estimation processing S5, CPU 1 first calculates a matching degree between a measured waveform acquired in a current machining cycle and a measured waveform acquired in a previous machining cycle (S5A).

Here, the matching degree is an index indicating a degree of matching between two waveforms. The matching degree is, for example, a cosine similarity degree, Euclidean distance, or Manhattan distance between two waveforms in a punching period. Instead of the matching degree, CPU 1 may calculate a loss that is an index indicating a degree of mismatching between two waveforms. Both the matching degree and the mismatching degree are examples of a “similarity degree” which is an index indicating a degree of similarity between two waveforms.

Subsequently, CPU 1 determines whether or not the calculated matching degree exceeds a preset threshold value (S5B).

There is usually a large difference between the waveform in a case where chipping illustrated in FIG. 3 does not occur and the waveform in a case where chipping illustrated in FIG. 10B occurs, as compared with a case where the tool is simply worn. This is because chipping occurs when a portion having a certain size (zone length W2 and retreating amount B2) in the tool missing at a time (between a pre-machining cycle and a current machining cycle).

A waveform change before and after the occurrence of chipping shows a tendency different from a waveform change due to wear that causes a small change. Accordingly, CPU 1 can estimate whether or not chipping newly occurs by using a matching degree between the measured waveform acquired in the previous machining cycle and the measured waveform acquired in the previous machining cycle.

In a case where it is determined that the matching degree exceeds the threshold value in step S5B (Yes in S5B), CPU 1 executes chipping estimation processing S53. Details of chipping estimation processing S53 will be described later.

In a case where it is determined in step S5B that the matching degree does not exceed the threshold value (No in S5B), CPU 1 sequentially executes workpiece thickness estimation processing S50, punch wear amount estimation processing S51, and die wear amount estimation processing S52. In a case where the matching degree does not exceed the threshold value, since it is estimated that chipping does not occur, chipping estimation processing S53 is not executed.

The reason why steps S50, S51, and S52 are executed in this order is to preferentially estimate the workpiece thickness over the punch wear and the die wear since the workpiece thickness generally changes whenever the workpiece is replaced, whereas the punch wear and the die wear gradually change as compared with the workpiece thickness. In addition, the reason why punch wear amount estimation processing S51 is executed before die wear amount estimation processing S52 is that the punch wear amount is estimated more preferentially than the die wear amount since the progress of the punch wear is faster than the progress of the die wear.

In normal state estimation processing S5, a value of a clearance of state data 22 is fixed to a value estimated in previous machining state estimation processing. The reason for fixing the clearance is that, in normal state estimation processing S5 in which a predetermined period elapses from the replacement or polishing of the tool, the clearance does not change at all or hardly even though the press machining is repeated.

In the present exemplary embodiment, in order to improve the efficiency of the data processing by CPU 1, an example in which chipping estimation processing S53 is performed only in a case where a possibility of occurrence is high after a possibility that chipping newly occurs is estimated (S5A and S5B) will be described, but the present disclosure is not limited thereto. For example, unlike FIG. 12, CPU 1 may sequentially execute chipping estimation processing S53 workpiece thickness estimation processing S50, punch wear amount estimation processing S51, and die wear amount estimation processing S52 in order to constantly perform the chipping estimation processing.

Hereinafter, first, details of a case where it is estimated that chipping does not occur (No in S5B) will be described.

### [2-2-2-2. Workpiece Thickness Estimation Processing S50]

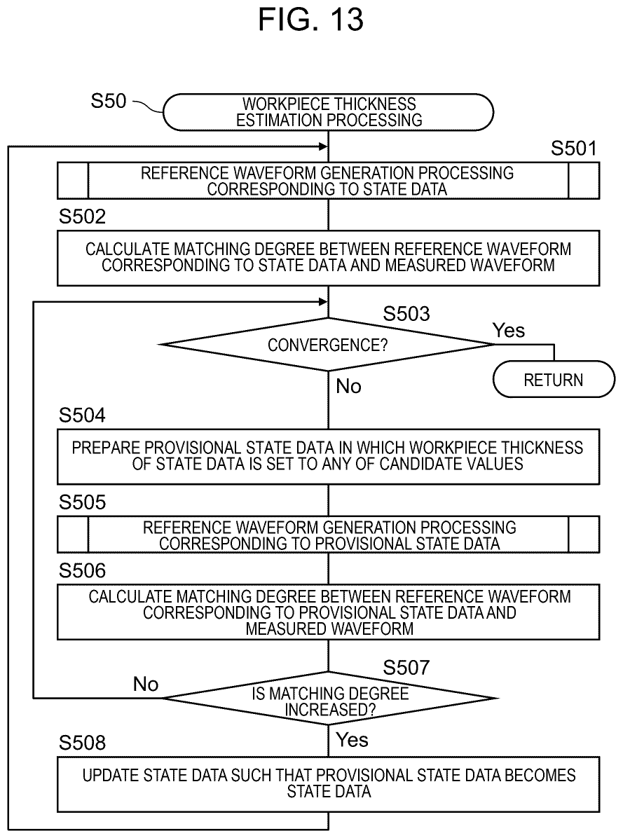

FIG. 13 is a flowchart illustrating workpiece thickness estimation processing S50 illustrated in FIG. 12. In workpiece thickness estimation processing S50, CPU 1 first executes reference waveform generation processing S501 corresponding to the state data.

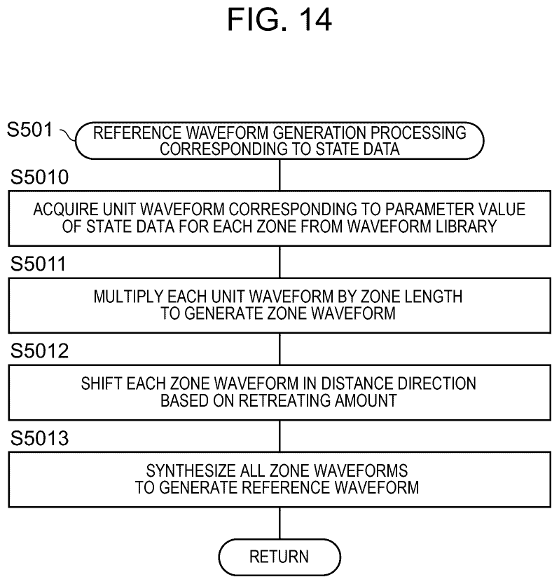

FIG. 14 is a flowchart illustrating reference waveform generation processing S501 corresponding to the state data of FIG. 13. First, CPU 1 acquires the unit waveform corresponding to the parameter value of state data 22 for each zone from waveform library 23 (S5010).

Subsequently, CPU 1 multiplies each unit waveform by the zone length to generate the zone waveform for every zone (S5011).

Subsequently, CPU 1 shifts the zone waveform for every zone in the distance direction by the retreating amount (S5012).

Subsequently, CPU 1 generates the reference waveform indicating the load over the overall length of the punched contour by synthesizing all the zone waveforms (S5013). The synthesis of the plurality of waveforms means, for example, taking the sum of the plurality of waveforms.

Referring back to FIG. 13, CPU 1 calculates the matching degree between the reference waveform corresponding to state data 22 generated in step S501 and the measured waveform acquired in step S1 (S502). The matching degree in step S502 is calculated similarly to the matching degree in step S5A, for example.

Subsequently, CPU 1 determines whether or not loop processing in workpiece thickness estimation processing S50 converges (completes) (S503). A case where the loop processing converges means that all candidate values that can be selected based on a predetermined selection rule are set in all zones of provisional state data. In step S503, CPU 1 determines whether or not all the candidate values for the workpiece thickness are set as workpiece thicknesses in zones A1 and A2 of the provisional state data, as the convergence determination.

In a case where it is determined that the loop processing in workpiece thickness estimation processing S50 does not converge in step S503 (No in S503), CPU 1 executes step S504, and in a case where it is determined that the loop processing converges (Yes in S503), CPU 1 terminates workpiece thickness estimation processing S50.

In step S504, CPU 1 prepares the provisional state data by changing state data 22 for every zone to set the workpiece thickness to any one of the candidate values for the workpiece thickness (S504). Note that, in step S504, the punch wear amount, the die wear amount, and the clearance, which are other parameters of the provisional state data, are fixed to a previously estimated punch wear amount, die wear amount, and clearance.

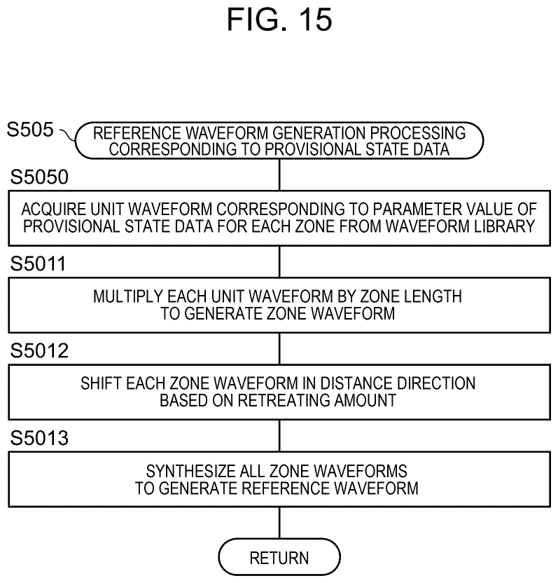

Subsequently, CPU 1 executes reference waveform generation processing S505 corresponding to the provisional state data. FIG. 15 is a flowchart illustrating reference waveform generation processing S505 corresponding to the provisional state data of FIG. 13. Reference waveform generation processing S505 corresponding to the provisional state data includes step S5050 instead of step S5010 as compared with reference waveform generation processing S501 corresponding to the state data in FIG. 14.

In reference waveform generation processing S505 corresponding to the provisional state data of FIG. 15, CPU 1 first acquires the unit waveform corresponding to the parameter value of the provisional state data for each zone from waveform library 23 (S5050). Subsequent steps S5011 to S5013 are similar to reference waveform generation processing S501 corresponding to the state data in FIG. 14.

Referring back to FIG. 13, CPU 1 calculates the matching degree between the reference waveform corresponding to the provisional state data generated in step S505 and the measured waveform acquired in step S1 (S506).

Subsequently, CPU 1 determines whether or not the matching degree calculated in step S504 increases as compared with the matching degree calculated in latest step S502 (S507). In a case where it is determined that the matching degree increases (Yes in S507), CPU 1 proceeds to step S508, and in a case where it is determined that the matching degree does not increase (No in S507), CPU 1 returns to step S503.

In step S508, CPU 1 updates state data 22 such that the provisional state data prepared in step S504 becomes state data 22 (S508). When step S508 is terminated, CPU 1 returns to step S501.

As described above, in a case where it is determined in step S503 that the loop processing in workpiece thickness estimation processing S50 converges (Yes in S503), CPU 1 terminates workpiece thickness estimation processing S50 and executes punch wear amount estimation processing S51 (see FIG. 12). In the above example, in a case where all loops in which the workpiece thicknesses in zones A1 and A2 of the provisional state data are set to 46 μm, 48 μm, 50 μm, 52 μm, and 54 μm are completed, CPU 1 terminates workpiece thickness estimation processing S50.

### [2-2-2-3. Punch Wear Amount Estimation Processing S51]

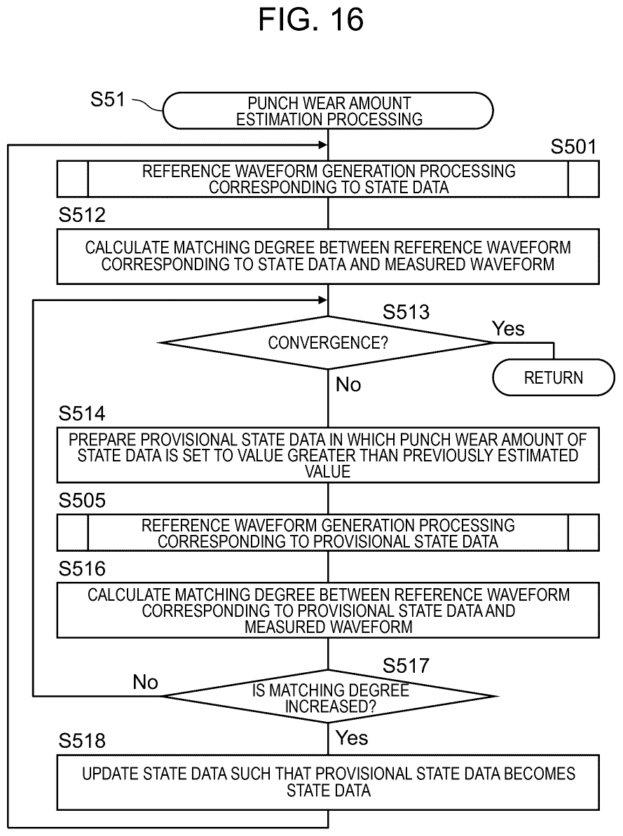

FIG. 16 is a flowchart illustrating punch wear amount estimation processing S51 illustrated in FIG. 12. In punch wear amount estimation processing S51, CPU 1 first executes reference waveform generation processing S501 (see FIG. 14) corresponding to the state data. Subsequently, CPU 1 calculates the matching degree between the reference waveform corresponding to state data 22 generated in step S501 and the measured waveform acquired in step S1 (S512).

Subsequently, CPU 1 determines whether or not the loop processing in punch wear amount estimation processing S51 converges (S513). That is, CPU 1 determines whether or not all candidate values more than the punch wear amount estimated in the previous machining state estimation processing, among the candidate values for the punch wear amount, are set in each zone of the provisional state data.

CPU 1 executes step S514 in a case where it is determined in step S513 that the loop processing in punch wear amount estimation processing S51 does not converge (No in S513), and terminates punch wear amount estimation processing S51 in a case where it is determined that the loop processing converges (Yes in S513).

In step S514, CPU 1 prepares the provisional state data by changing state data 22 for every zone to set the punch wear amount to a value more than the previously estimated punch wear amount (S514). In the above example, in a case where the previously estimated punch wear amount is 4 μm, CPU 1 sets the punch wear amount of the provisional state data to any one of 6 μm, 8 μm, 10 μm, and 12 μm.

Subsequently, CPU 1 executes reference waveform generation processing S505 corresponding to the provisional state data. CPU 1 calculates the matching degree between the reference waveform corresponding to the provisional state data generated in step S505 and the measured waveform acquired in step S1 (S516).

CPU 1 determines whether or not the matching degree calculated in step S516 increases as compared with the matching degree calculated in latest step S512 (S517). CPU 1 proceeds to step S518 in a case where it is determined that the matching degree increases (Yes in S517), and returns to step S513 in a case where it is determined that the matching degree does not increase (No in S517).

In step S518, CPU 1 updates state data 22 such that the provisional state data prepared in step S514 becomes state data 22 (S518). When step S518 is terminated, CPU 1 returns to step S501.

### [2-2-2-4. Die Wear Amount Estimation Processing S52]

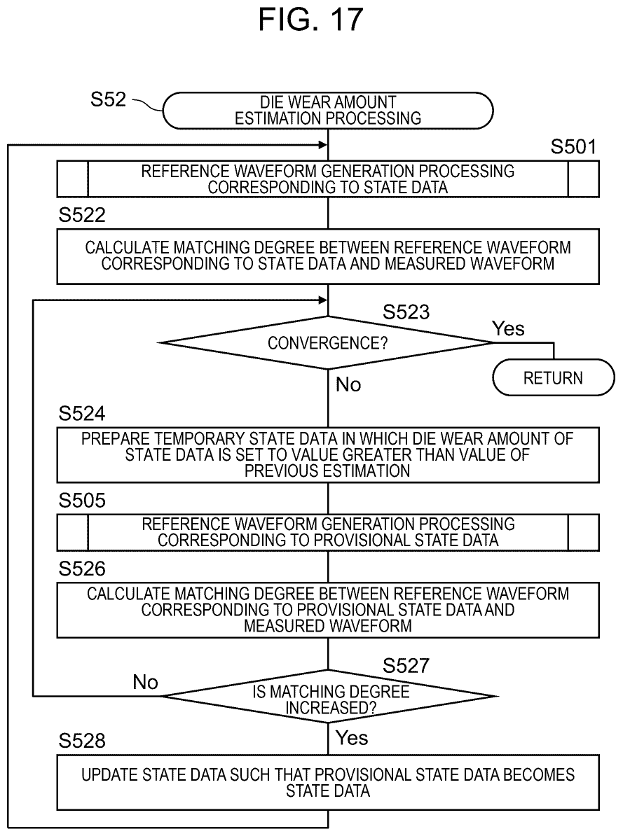

FIG. 17 is a flowchart illustrating die wear amount estimation processing S52 illustrated in FIG. 12. In die wear amount estimation processing S52, CPU 1 first executes reference waveform generation processing S501 (see FIG. 14) corresponding to the state data. Subsequently, CPU 1 calculates the matching degree between the reference waveform corresponding to state data 22 generated in step S501 and the measured waveform acquired in step S1 (S522).

Subsequently, CPU 1 determines whether or not the loop processing in die wear amount estimation processing S52 converges (S523). That is, CPU 1 determines whether or not all candidate values more than the die wear amount estimated in the previous machining state estimation processing, among the candidate values for the die wear amount, are set in each zone of the provisional state data.

CPU 1 executes step S524 in a case where it is determined that the loop processing in die wear amount estimation processing S52 does not converge (No in S523), and terminates die wear amount estimation processing S52 in a case where it is determined that the loop processing converges (Yes in S523).

In step S524, CPU 1 prepares the provisional state data by changing state data 22 for every zone to set the die wear amount to a value more than the previously estimated die wear amount (S524).

Subsequently, CPU 1 executes reference waveform generation processing S505 corresponding to the provisional state data. CPU 1 calculates the matching degree between the reference waveform corresponding to the provisional state data generated in step S505 and the measured waveform acquired in step S1 (S526).

CPU 1 determines whether or not the matching degree calculated in step S526 increases as compared with the matching degree calculated in latest step S522 (S527). CPU 1 proceeds to step S528 in a case where it is determined that the matching degree increases (Yes in S527), and returns to step S523 in a case where it is determined that the matching degree does not increase (No in S527).

In step S528, CPU 1 updates state data 22 such that the provisional state data prepared in step S524 becomes state data 22 (S528). When step S528 is terminated, CPU 1 returns to step S501.

As described above, in normal state estimation processing S5, in a case where it is estimated that chipping does not occur (No in S5B of FIG. 12), CPU 1 estimates state data 22. In estimated state data 22, punch wear amounts P1 and P2, die wear amounts D1 and D2, clearances C1 and C2, and workpiece thickness T illustrated in FIG. 9 are specified. For example, for first zone A1, punch wear amount P1, die wear amount D1, clearance C1, and workpiece thickness T are specified. In doing so, machining-state-estimating device 100 can estimate parameters for every zone.

### [2-2-2-5. Chipping Estimation Processing S53]

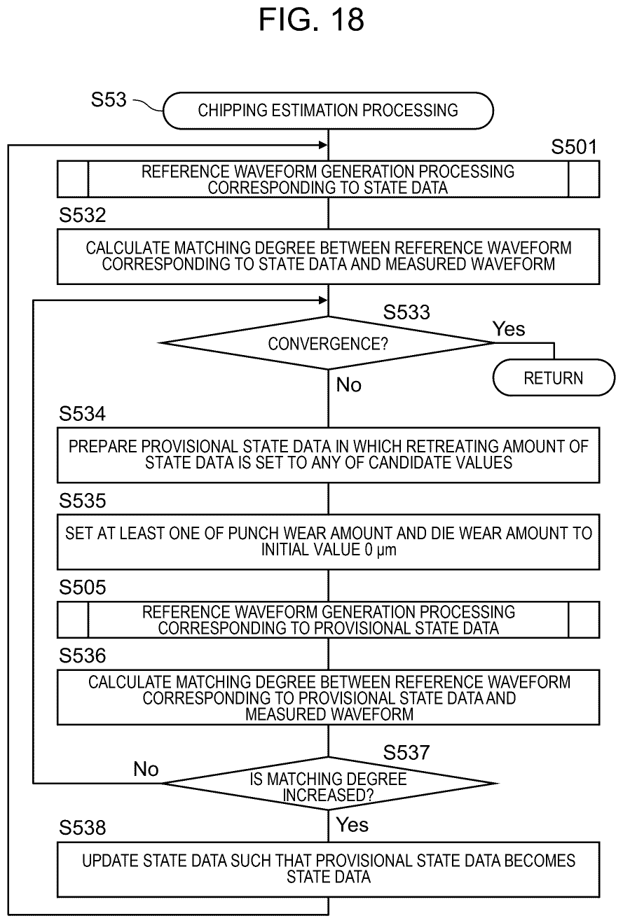

Next, chipping estimation processing S53 in a case where the matching degree exceeds the threshold value in step S5B of FIG. 12 (Yes in S5B) will be described. FIG. 18 is a flowchart illustrating chipping estimation processing S53 illustrated in FIG. 12.

First, CPU 1 executes reference waveform generation processing S501 (see FIG. 14) corresponding to the state data. Subsequently, CPU 1 calculates the matching degree between the reference waveform corresponding to state data 22 generated in step S501 and the measured waveform acquired in step S1 (S532).

Subsequently, CPU 1 determines whether or not the loop processing in chipping estimation processing S53 converges (S533). For example, CPU 1 performs the following two determinations. That is, first, CPU 1 determines whether or not all candidate values more than zone length W2 estimated in the previous machining state estimation processing, among the candidate values for zone length W2 of second zone A2, are set in second zone A2 of the provisional state data. Secondly, CPU 1 determines whether or not all candidate values more than retreating amount B2 estimated in the previous machining state estimation processing, among the candidate values for retreating amount B2 in second zone A2, are set in second zone A2 of the provisional state data.

CPU 1 executes step S534 in a case where it is determined in step S533 that the loop processing in chipping estimation processing S53 does not converge (No in S533), and terminates chipping estimation processing S53 in a case where it is determined that the loop processing converges (Yes in S533).

In step S534, CPU 1 changes state data 22 to set each of zone length W2 and retreating amount B2 to one of candidate values more than zone length W2 and retreating amount B2 estimated last time to prepare provisional state data (S534). Zone length W2 is adjusted such that the sum of zone lengths W1 and W2 is equal to total zone length W of the punched contour.

In the above example, in a case where previously estimated zone length W2 is 2 mm, CPU 1 sets current zone length W2 to any one of the candidate values of from 3 mm to total zone length W inclusive. In addition, in a case where previously estimated retreating amount B2 is 1 mm, CPU 1 sets current retreating amount B2 to any one of candidate values of from 2 mm to 5 mm inclusive.

Subsequently, CPU 1 sets at least one of punch wear amount P2 and die wear amount D2 corresponding to zone A2 to an initial value of 0 μm (S535). In a case where chipping newly occurs, since chipping misses including the wear in the chipping region, the chipping region is not worn or the wear cannot be conceived. As a result, at least one of punch wear amount P2 and die wear amount D2 is returned to the initial state.

Subsequently, CPU 1 executes reference waveform generation processing S505 corresponding to the provisional state data. CPU 1 calculates the matching degree between the reference waveform corresponding to the provisional state data generated in step S505 and the measured waveform acquired in step S1 (S536).

CPU 1 determines whether or not the matching degree calculated in step S536 increases as compared with the matching degree calculated in latest step S532 (S537). CPU 1 proceeds to step S538 in a case where it is determined that the matching degree increases (Yes in S537), and returns to step S533 in a case where it is determined that the matching degree does not increase (No in S537).

In step S538, CPU 1 updates state data 22 such that the provisional state data prepared in step S534 becomes state data 22 (S538). When step S538 is terminated, CPU 1 returns to step S501.

As described above, in normal state estimation processing S5, CPU 1 estimates state data 22. In estimated state data 22, zone lengths W1 and W2, punch wear amounts P1 and P2, die wear amounts D1 and D2, clearances C1 and C2, retreating amounts B1 and B2, and workpiece thickness T illustrated in FIG. 9 are specified. For second zone A2, zone length W2, punch wear amount P2, die wear amount D2, clearance C2, retreating amount B2, and workpiece thickness T are specified.

In doing so, machining-state-estimating device 100 can estimate parameters for every zone. In particular, retreating amount B2 of state data 22 updated in chipping estimation processing S53 indicates the presence or absence and degree of chipping.

### [2-2-3. Post-Polishing State Estimation Processing S6]

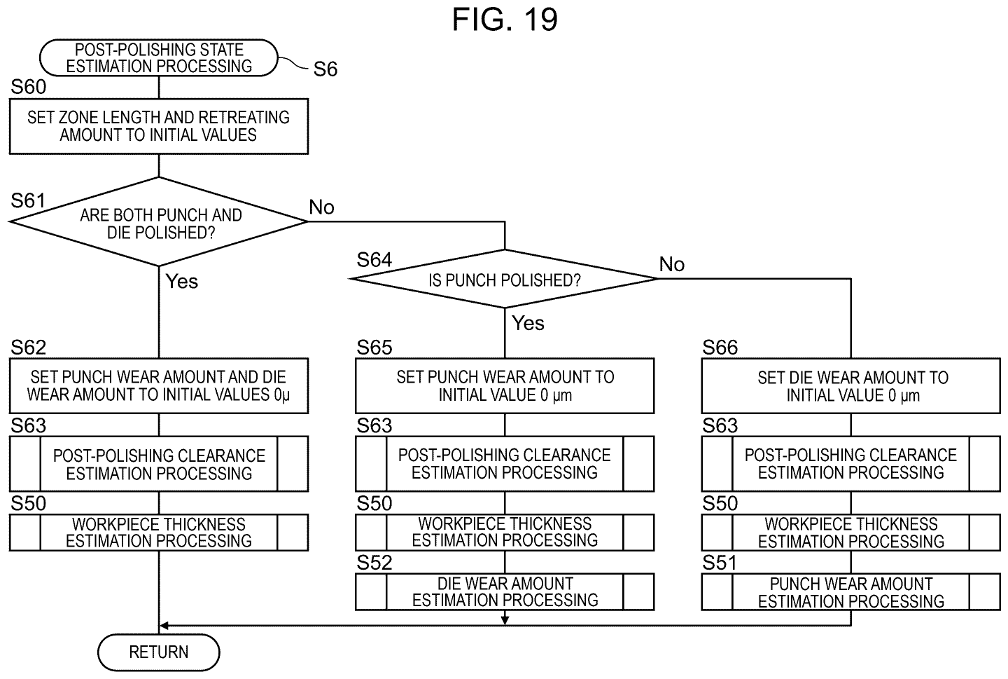

FIG. 19 is a flowchart illustrating a processing flow of post-polishing state estimation processing S6 illustrated in FIG. 11. In a case where chipping occurs, the tool is polished until chipping region 73C is eliminated over an overall region of the punched contour such that favorable processing can be obtained in repolishing by the maintenance of a mold. Accordingly, in the above example, CPU 1 sets zone length W1 to total zone length W, zone length W2 to 0 mm, and retreating amounts B1 and B2 to initial values (S60).

In addition, in post-polishing state estimation processing S6, processing to be executed differs depending on whether the polished tool is a punch, a die, or both the punch and the die.

For example, CPU 1 determines whether or not both the punch and the die are polished (S61). In the above-described example, CPU 1 determines whether or not both a die polishing signal indicating that the die is polished and a punch polishing signal indicating that the punch is polished are received. CPU 1 proceeds to step S62 in a case where it is determined that both the punch and the die are polished (Yes in S61), and proceeds to step S64 in the other case (No in S61).

In step S64, CPU 1 determines whether or not the punch is polished. CPU 1 proceeds to step S65 in a case where it is determined that the punch is polished (Yes in S64), and proceeds to step S66 in the other case (No in S64). That is, step S62 is executed in a case where both the punch and the die are polished, step S65 is executed in a case where only the punch is polished, and step S66 is executed in a case where only the die is polished.

In step S62, CPU 1 sets the punch wear amount and the die wear amount to 0 m as initial values. After the punch wear amount and the die wear amount are fixed in this manner, CPU 1 executes processing of estimating the clearance (hereinafter, referred to as “post-polishing clearance estimation processing”.) S63 and workpiece thickness estimation processing S50. Instead of the example of FIG. 19, post-polishing clearance estimation processing S63 may be executed after workpiece thickness estimation processing S50. Details of post-polishing clearance estimation processing S63 will be described later.

CPU 1 sets the punch wear amount to 0 μm, which is the initial value (S65) in a case where it is determined in step S64 that the punch is polished (Yes in S64), and then executes post-polishing clearance estimation processing S63, workpiece thickness estimation processing S50, and die wear amount estimation processing S52. Instead of the example of FIG. 19, post-polishing clearance estimation processing S63 may be executed after workpiece thickness estimation processing S50 and die wear amount estimation processing S52.

CPU 1 sets the die wear amount to 0 μm, which is the initial value (S66) in a case where it is determined in step S64 that the punch is not polished (No in S64), and then executes post-polishing clearance estimation processing S63, workpiece thickness estimation processing S50, and punch wear amount estimation processing S51. Instead of the example of FIG. 15, post-polishing clearance estimation processing S63 may be executed after workpiece thickness estimation processing S50 and punch wear amount estimation processing S51.

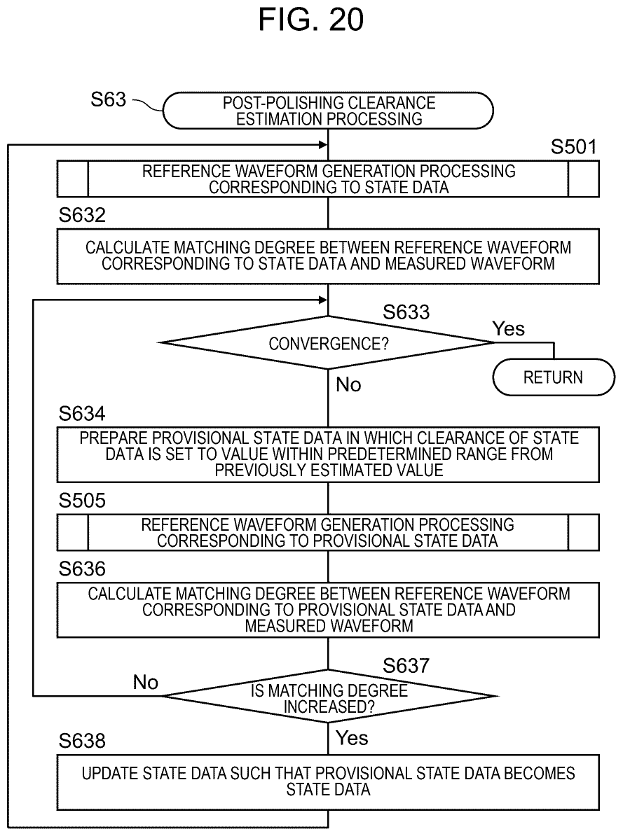

FIG. 20 is a flowchart illustrating post-polishing clearance estimation processing S63 illustrated in FIG. 19. In post-polishing clearance estimation processing S63, CPU 1 first executes reference waveform generation processing S501 (see FIG. 14) corresponding to the state data. Subsequently, CPU 1 calculates the matching degree between the reference waveform corresponding to state data 22 generated in step S501 and the measured waveform acquired in step S1 (S632).

Subsequently, CPU 1 determines whether or not the loop processing in post-polishing clearance estimation processing S63 converges (S633). That is, CPU 1 determines whether or not all candidate values within a predetermined range from the clearance estimated in the previous machining state estimation processing, among the candidate values for the clearance, are set in the provisional state data.

CPU 1 executes step S634 in a case where it is determined that the loop processing in post-polishing clearance estimation processing S63 does not converge (No in S633), and terminates post-polishing clearance estimation processing S63 in a case where it is determined that the loop processing converges (Yes in S633).

In step S634, CPU 1 prepares the provisional state data by changing state data 22 to set the clearance to a value within a predetermined range from a previously estimated clearance (S634). For example, in a case where the previously estimated clearance is 5 μm, CPU 1 sets the clearance of the provisional state data to a value within a range of ±1 μm from 5 μm, that is, 4 μm or 6 μm. The reason why a change range of the clearance is limited to the predetermined range is that it has been found that the clearance is hardly changed even though the tool is polished unlike a case where the tool is replaced.

Subsequently, CPU 1 executes reference waveform generation processing S505 corresponding to the provisional state data. CPU 1 calculates the matching degree between the reference waveform corresponding to the provisional state data generated in step S505 and the measured waveform acquired in step S1 (S636).

CPU 1 determines whether or not the matching degree calculated in step S636 increases as compared with the matching degree calculated in latest step S632 (S637). CPU 1 proceeds to step S638 in a case where it is determined that the matching degree increases (Yes in S637), and returns to step S633 in a case where it is determined that the matching degree does not increase (No in S637).

In step S638, CPU 1 updates state data 22 such that the provisional state data prepared in step S634 becomes state data 22 (S638). When step S638 is terminated, CPU 1 returns to step S501.

### [2-2-4. Post-Replacement State Estimation Processing S7]

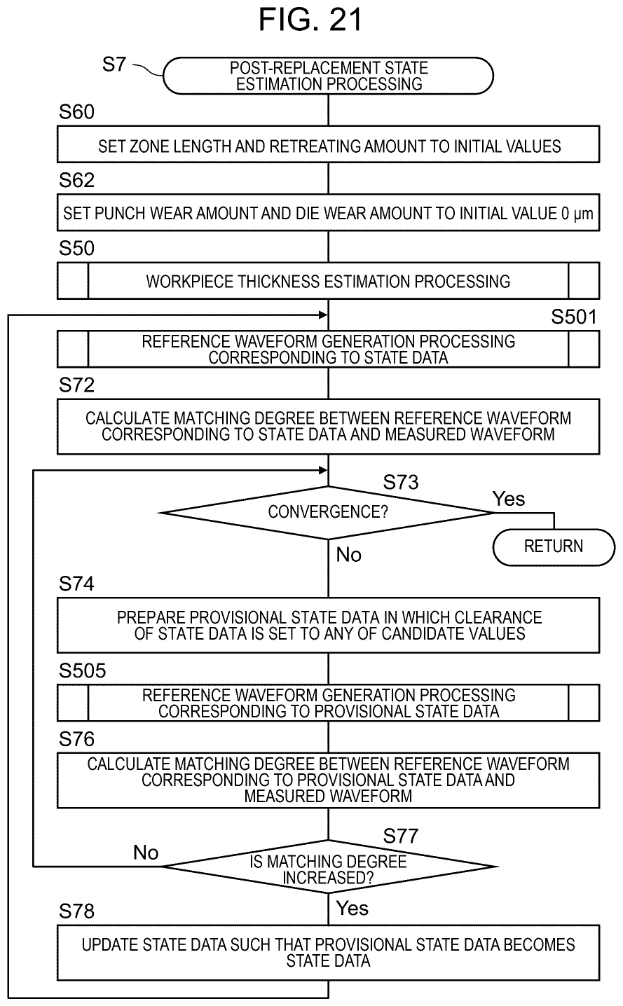

FIG. 21 is a flowchart illustrating post-replacement state estimation processing S7 illustrated in FIG. 11.

In post-replacement state estimation processing S7, first, in the above example, CPU 1 sets zone length W1 to total zone length W, zone length W2 to 0, and retreating amounts B1 and B2 to initial values (S60). In the present exemplary embodiment, the initial values of retreating amounts B1 and B2 are both 0 mm.

Subsequently, CPU 1 sets the punch wear amount and the die wear amount to 0 m as initial values (S62). Subsequently, CPU 1 executes workpiece thickness estimation processing S50.

Subsequently, CPU 1 executes reference waveform generation processing S501 (see FIG. 14) corresponding to the state data. Subsequently, CPU 1 calculates the matching degree between the reference waveform corresponding to state data 22 generated in step S501 and the measured waveform acquired in step S1 (S72).

Subsequently, CPU 1 determines whether or not the loop processing in the post-replacement state estimation processing S7 converges (S73). That is, CPU 1 determines whether or not all the candidate values for the clearance are set in the provisional state data.

CPU 1 executes step S74 in a case where it is determined that the loop processing in post-replacement state estimation processing S7 does not converge (No in S73), and terminates post-replacement state estimation processing S7 in a case where it is determined that the loop processing converges (Yes in S73).

In step S74, CPU 1 prepares the provisional state data by changing state data 22 to set the clearance to any one of the candidate values for the clearance (S74).

Subsequently, CPU 1 executes reference waveform generation processing S505 corresponding to the provisional state data. CPU 1 calculates the matching degree between the reference waveform corresponding to the provisional state data generated in step S505 and the measured waveform acquired in step S1 (S76).

CPU 1 determines whether or not the matching degree calculated in step S76 increases as compared with the matching degree calculated in latest step S72 (S77). CPU 1 proceeds to step S78 in a case where it is determined that the matching degree increases (Yes in S77), and returns to step S73 in a case where it is determined that the matching degree does not increase (No in S77).

In step S78, CPU 1 updates state data 22 such that the provisional state data prepared in step S74 becomes state data 22 (S78). When step S78 is terminated, CPU 1 returns to step S501.

In a case where the width and/or depth of chipping is not within a predetermined range in state data 22 as the estimation result, machining-state-estimating device 100 may notify the user. Alternatively, or in addition thereto, in a case where the punch wear amount or the die wear amount is more than or equal to the predetermined threshold value and/or in a case where the clearance is not within the predetermined range, machining-state-estimating device 100 may notify the user. As a result, the user can perform maintenance such as the replacement of the tool. Such notification is performed, for example, by means of turning on or blinking an LED in red, causing a speaker to generate a warning sound, causing a display to display state data 22, or the like.

### 3. Effects or the Like

As described above, machining-state-estimating device 100 according to the present exemplary embodiment includes storage device 2 and CPU 1, which is an example of the processor. Storage device 2 stores the unit waveform, which is an example of the criterion reference data corresponding to the state parameter that defines the machining state of pressing machine 50, and the contour parameter, which is an example of the zone shape information. The contour parameter defines the zone length indicating the length of each of zones A1 and A2 representing the punched contour by pressing machine 50, and the retreating amount indicating the dimensional change of the punched contour from the predetermined position in each zone. CPU 1 acquires the measured waveform indicating the measurement result of the machining load by pressing machine 50 (S1). CPU 1 generates the reference waveform regarding the machining load based on the unit waveform and the contour parameter (S501 and S505). CPU 1 determines the matching degree between the reference waveform and the measured waveform (S502 and S506), and estimates the machining state in each zone based on the determined matching degree.

In accordance with this configuration, the machining state in each of the plurality of zones obtained by dividing the punched contour is estimated, and thus, the machining state by pressing machine 50 can be estimated more accurately than in the related art. For example, chipping of punch 73 and/or die 63 may be detected.

The state parameter defines the machining state per predetermined unit length of the punched contour, and the unit waveform may correspond to the state parameter per predetermined unit length of the punched contour. In the processing of generating the reference waveform, CPU 1 may generate the zone waveform for every zone regarding the machining load by multiplying the unit waveform by the ratio of the zone length to the unit length for every zone (S5011). CPU 1 generates the reference waveform regarding the machining load over the overall length of the punched contour by synthesizing the zone waveforms for every zone (S5013). In accordance with this configuration, the machining state can be estimated more accurately than in the related art.

The measured waveform and the unit waveform may be data indicating a relationship between the machining load by pressing machine 50 and a moving distance of punch 73 with respect to die 63 of pressing machine 50. In this case, in the synthesizing processing, CPU 1 adds the retreating amount corresponding to each zone defined in the contour parameter to the zone waveform for every zone (S5012), and synthesizes the zone waveforms for the zones to which the retreating amount is added. In accordance with this configuration, the machining state can be estimated more accurately by synthesizing the zone waveforms in consideration of the retreating amount of each zone.

In the synthesizing processing, CPU 1 may generate the reference waveform regarding the machining load over the overall length of the punched contour by calculating the sum of the zone waveforms for every zone. In accordance with this configuration, the machining state can be estimated more accurately than in the related art.

CPU 1 may search for the reference waveform having the maximum matching degree with the measured waveform, and may determine the state parameter and the contour parameter corresponding to the unit waveform that is the basis of the searched reference waveform, as the estimated parameters representing the machining state at the time of measuring the measured waveform.

In the related art, there is known a technique of determining that the measured waveform is normal in a case where the measured waveform is within a predetermined range between a predetermined upper limit value and a predetermined lower limit value and determining that the measured waveform is abnormal in the other case. However, in the related art, when the predetermined range is set to be wide, it is not possible to detect abnormality in the device such as wear and chipping of the tool, and when the predetermined range is set to be narrow, there is a problem that it is determined that the device is abnormal although the device is normal. In contrast, in accordance with machining-state-estimating device 100 according to the present exemplary embodiment that searches for the reference waveform, the machining state can be estimated more accurately than in the related art.

CPU 1 may search for the reference waveform having the maximum matching degree with the measured waveform by sequentially changing the parameter within a predetermined range with the estimated parameter already determined by CPU 1 as the criterion. In accordance with this configuration, the machining state can be estimated more accurately by performing search based on the above criterion. In addition, a calculation amount for estimation can be reduced as compared with a case where there is no criterion described above.

The estimated parameter may include an estimated zone length estimated as a zone length at the time of measuring the measured waveform and an estimated retreating amount estimated as a retreating amount at the time of measuring the measured waveform. In accordance with this configuration, the retreating amount can be estimated more accurately than in the related art.

When a signal indicating that punch 73 or die 63 of pressing machine 50 is replaced or polished, CPU 1 may set the estimated zone length and the estimated retreating amount to initial values (S60). In accordance with this configuration, the wear amount of punch 73 or die 63 can be estimated more accurately. In addition, since the estimated zone length and the estimated retreating amount are set to the initial values, the calculation amount for searching and estimating the punch wear parameter or the die wear parameter can be reduced.

Pressing machine 50 may perform cycle machining. In this case, CPU 1 acquires the measured waveform of each cycle of pressing machine 50 in time series. In a case where a matching degree between a current measured waveform acquired in a specific machining cycle and a measured waveform acquired in a machining cycle immediately before the specific machining cycle is more than a predetermined threshold value (Yes in S5B), CPU 1 searches for the reference waveform having the maximum matching degree with the current measured waveform, and determines the contour parameter corresponding to the unit waveform that is the basis of the searched reference waveform as the estimated parameter representing the machining state at the time of measuring the current measured waveform (S53). In accordance with this configuration, the retreating amount can be estimated more accurately than in the related art.

The state parameters may include wear parameters that define the degree of wear of punch 73 or die 63 of pressing machine 50. CPU 1 searches for the reference waveform having the maximum matching degree with the current measured waveform in a case where the matching degree between the current measured waveform and the previous measured waveform is less than or equal to the threshold value (No in S5B), and determines the wear parameter corresponding to the unit waveform that is the basis of the searched reference waveform, as the estimated parameter representing the machining state at the time of measuring the current measured waveform. In a case where the matching degree between the current measured waveform and the previous measured waveform is more than the threshold value (Yes in S5B), the wear parameter may not be determined as the estimated parameter. In accordance with this configuration, it is possible to reduce the calculation amount for searching and estimating the punch wear parameter or the die wear parameter.

In a case where the matching degree between the current measured waveform and the previous measured waveform is more than the threshold value (Yes in S5B), CPU 1 may set the wear parameter as the estimated parameter to the initial value (S535). In accordance with this configuration, it is possible to reduce the calculation amount for searching and estimating the punch wear parameter or the die wear parameter.

As illustrated in FIG. 8, the retreating amount may be set to be constant in each zone. In accordance with this configuration, the calculation amount for the arithmetic operation (S5012) based on the retreating amount can be reduced.

### Modification of First Exemplary Embodiment

In the first exemplary embodiment, it has been described that first zone A1 of state data 22 corresponds to the zone in which chipping does not occur and second zone A2 corresponds to a zone in which chipping occurs, but the present disclosure is not limited thereto. For example, a zone obtained by dividing the punched contour may be added in a case where it is estimated that chipping occurs. That is, the number of zones in state data 22 in FIG. 9 is one in a case where chipping does not occur, and the number of zones is only plural in a case where it is estimated that chipping occurs.

In accordance with this configuration, the number of zones obtained by dividing the punched contour can be reduced until it is estimated that chipping occurs, and an arithmetic operation amount of CPU 1 can be reduced.

### Second Exemplary Embodiment

In the first exemplary embodiment, the example in which the retreating amount in second zone A2 is represented by representative value B2 of the actual retreating amount has been described. In contrast, in a second exemplary embodiment, a chipping state including a distribution in a depth direction is predicted. That is, in the second exemplary embodiment, the retreating amount may not be constant with respect to a direction of the chipping width, and may have a distribution. In the second exemplary embodiment, machining-state-estimating device 100 predicts a distribution of a retreating amount in the depth direction with respect to the direction of the chipping width by representing a distribution of chipping with a parameter.

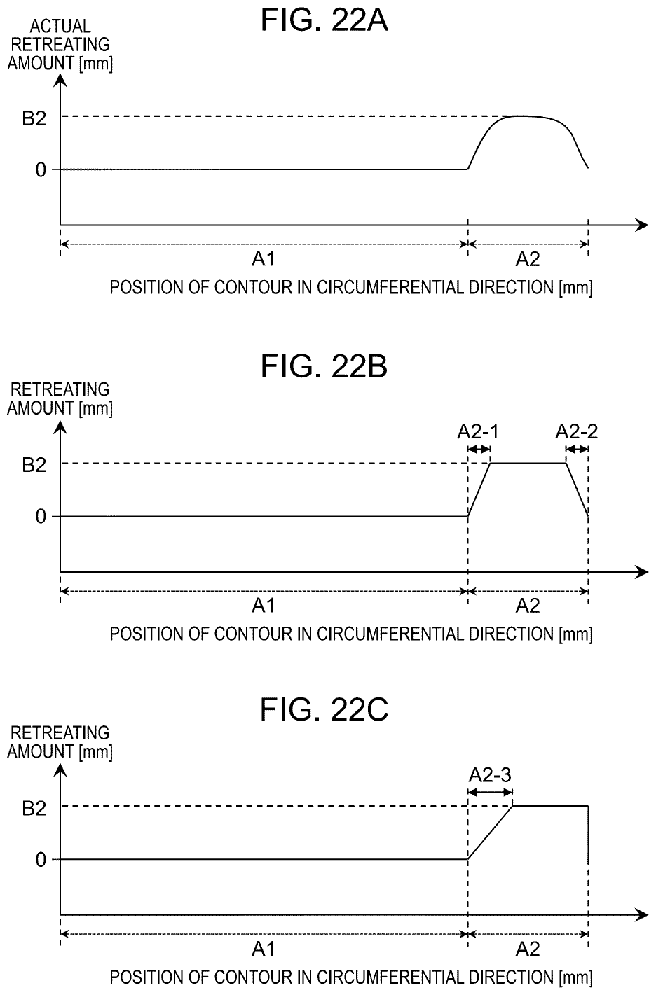

Hereinafter, such a second exemplary embodiment will be described with reference to FIGS. 22A to 25B.

FIG. 22A is a graph representing a relationship between the actual retreating amount of the edge of punch 73 and a position of the punched contour in the circumferential direction. FIG. 22A is the same as FIG. 7, and thus, a detailed description thereof will be omitted.

FIG. 22B is a diagram for explaining an example of the retreating amount parameter corresponding to the actual retreating amount in FIG. 22A. Unlike FIG. 8 of the first exemplary embodiment, in second zone A2 of FIG. 22B, the retreating amount parameter is not constant and has a distribution. Specifically, zones A2-1 and A2-2 in second zone A2 are portions where the retreating amount changes due to chipping, and this change is approximated by straight lines in FIG. 22B. In the example of FIG. 22B, an absolute value of an inclination of the straight line in zone A2-1 is equal to an absolute value of an inclination of the straight line in zone A2-2.

FIG. 22C is a diagram for explaining another example of the retreating amount parameter corresponding to the actual retreating amount in FIG. 22A. The graph of FIG. 22C is obtained by combining straight line portions having inclinations in zones A2-1 and A2-2 of FIG. 22B into one zone A2-3. Accordingly, an inclination of a straight line in zone A2-3 in FIG. 22B is ½ times the inclination of the straight line in zone A2-1. In the machining-state-estimating processing according to the present exemplary embodiment, since a similar result can be obtained by using any one of the retreating amount parameters illustrated in FIGS. 22B and 22C, the retreating amount parameter of FIG. 22C that can simplify the arithmetic operation as compared with FIG. 22B may be used.

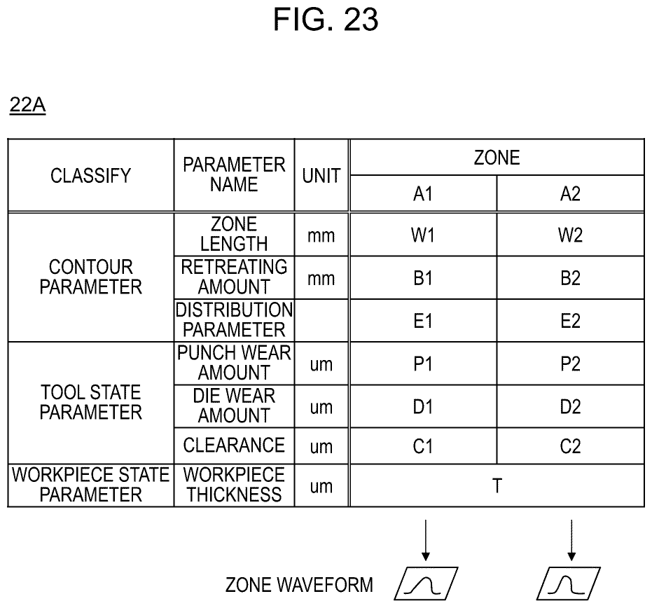

FIG. 23 is a table representing an example of state data 22A according to the present exemplary embodiment. State data 22A further includes a distribution parameter as the contour parameter as compared with state data 22 according to the first exemplary embodiment illustrated in FIG. 9. In state data 22A, a distribution parameter in first zone A1 is represented as E1, and a distribution parameter in second zone A2 is represented as E2.

In the present exemplary embodiment, distribution parameter E1 of first zone A1 in which chipping does not occur is 0. Distribution parameter E2 in second zone A2 where chipping occurs represents a waveform in zone A2 in FIG. 22C.

Note that, a chipping parameter according to the present exemplary embodiment corresponds to zone length W2, retreating amount B2, and distribution parameter E2.

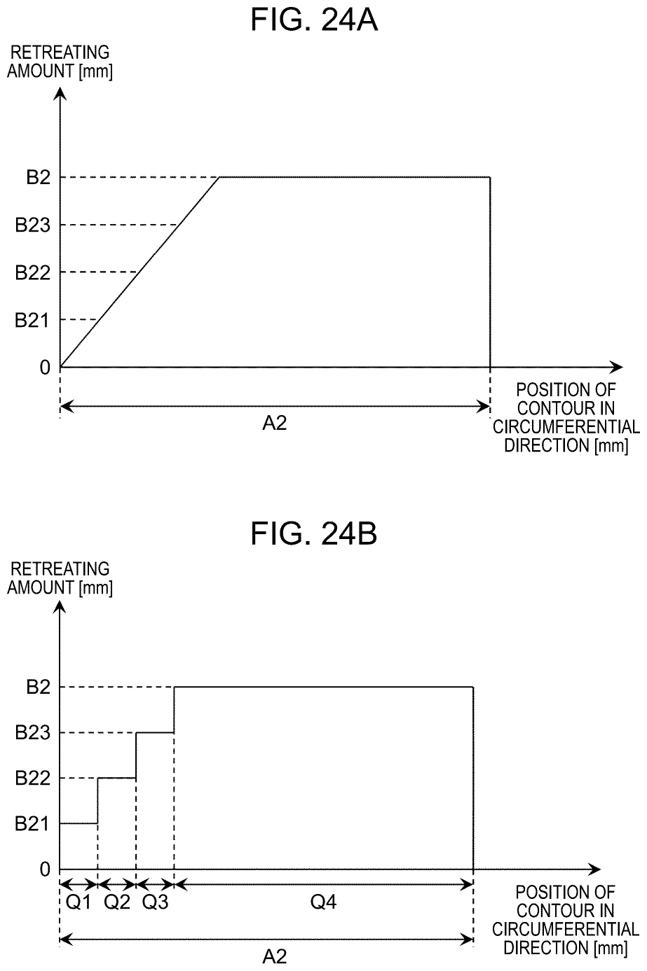

FIG. 24A is an enlarged view of second zone A2 in FIG. 22C, and is a diagram illustrating the distribution of the retreating amount in second zone A2 of state data 22A. FIG. 24B is a diagram illustrating zones Q1 to Q4 obtained by subdividing second zone A2 according to the retreating amount. In the present exemplary embodiment, the retreating amount is subdivided (discretized) for every constant amount. For example, in FIG. 24B, the retreating amount may be any amount including B2 and amounts B21, B22, and B23 obtained by dividing B2 into four. In the present exemplary embodiment, second zone A2 is divided into zones Q1, Q2, Q3, and Q4 corresponding to retreating amounts B21, B22, B23, and B2, based on distribution parameter E2 and retreating amount B2.

Although FIG. 24B illustrates a case where second zone A2 is subdivided into four zones, second zone A2 may be subdivided into two or three zones, or may be subdivided into five or more zones.

In a case where there is a parameter obtained by subdividing the contour parameter in state data 22A in the machining state estimation processing, CPU 1 of machining-state-estimating device 100 uses the parameter obtained by the subdivision. In the above example, CPU 1 performs the estimation processing by using parameters B21, B22, B23, and B2 obtained by the subdivision.

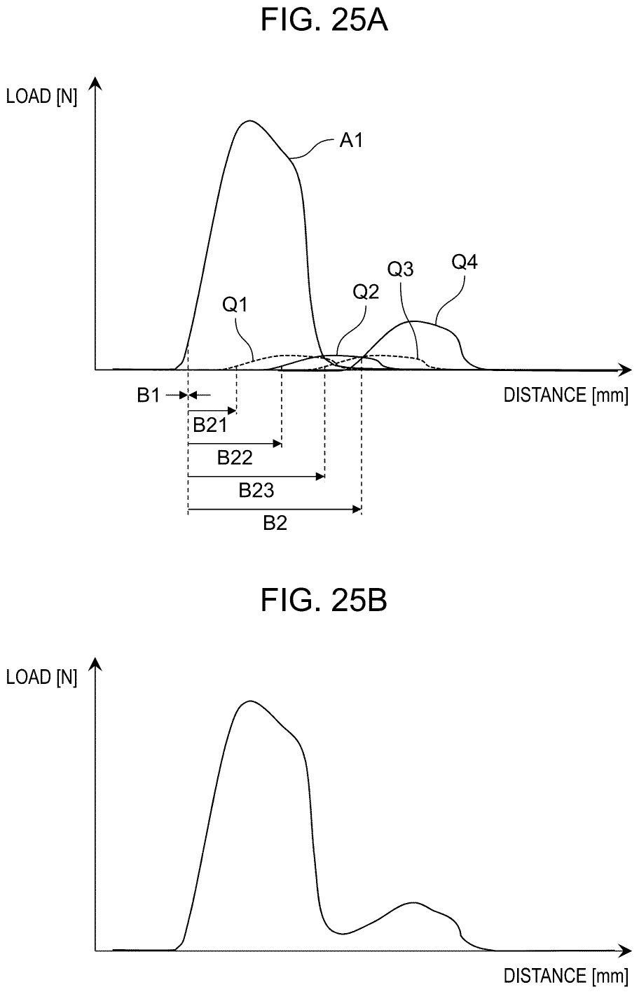

FIGS. 25A and 25B are graphs for explaining synthesis of waveforms in consideration of the retreating amount of punch 73 according to the present exemplary embodiment. As compared with FIG. 10A of the first exemplary embodiment, in FIG. 25A, instead of one waveform corresponding to second zone A2, there are four waveforms corresponding to zones Q1 to Q4. Note that, in FIG. 25A, waveforms corresponding to zones Q1 and Q3 are indicated by broken lines for the sake of convenience in order to facilitate discrimination of the waveforms.

As illustrated in FIG. 25A, waveforms corresponding to zones Q1 to Q4 are shifted in the distance direction by retreating amounts B1, B21, B22, B23, and B2 corresponding thereto in step S5012 (see FIG. 14).

FIG. 25B is a schematic graph representing a reference waveform obtained by adding five waveforms of FIG. 25A. In S5013, CPU 1 generates the reference waveform of FIG. 25B indicating the load over the overall length of the punched contour by synthesizing the five waveforms of FIG. 25A.

In the present exemplary embodiment, instead of step S534 of chipping estimation processing S53 illustrated in FIG. 18, CPU 1 executes processing of preparing provisional state data in which zone length W2, retreating amount B2, and distribution parameter E2, which are chipping parameters of the state data, are set to any one of the candidate values.

As described above, in the present exemplary embodiment, the retreating amount can be changed in accordance with the position of the zone length in the length direction in each zone. Unlike the first exemplary embodiment, machining-state-estimating device 100 according to the present exemplary embodiment estimates the machining state including the distribution of the retreating amount in the depth direction with respect to the direction of the chipping width by representing the distribution of the retreating amount with the parameter. As a result, machining-state-estimating device 100 can generate (S501 and S505) a reference waveform regarding a machining load having a higher matching degree with the measured waveform.

In addition, since machining-state-estimating device 100 according to the present exemplary embodiment more easily increases the matching degree between the measured waveform and the reference waveform, a condition of convergence (S533) can be obtained more quickly in chipping estimation processing S53.

In accordance with the configuration of the present exemplary embodiment, the machining state in each of the plurality of zones obtained by dividing the punched contour is estimated, and thus, the machining state by pressing machine 50 can be estimated more accurately than in the related art. For example, machining-state-estimating device 100 according to the present exemplary embodiment can detect the distribution of the retreating amount of the chipping of punch 73 and/or die 63.

### Modification of Second Exemplary Embodiment

The retreating amount in second zone A2 may be represented by a function.

An example of the function is a linear function. In the example of FIG. 22C, distribution parameter E2 indicates that the retreating amount is a linear function of the position of the contour in the circumferential direction.

The function may be, for example, a cumulative distribution function of a normal distribution in which the distribution parameter is variance value σ.

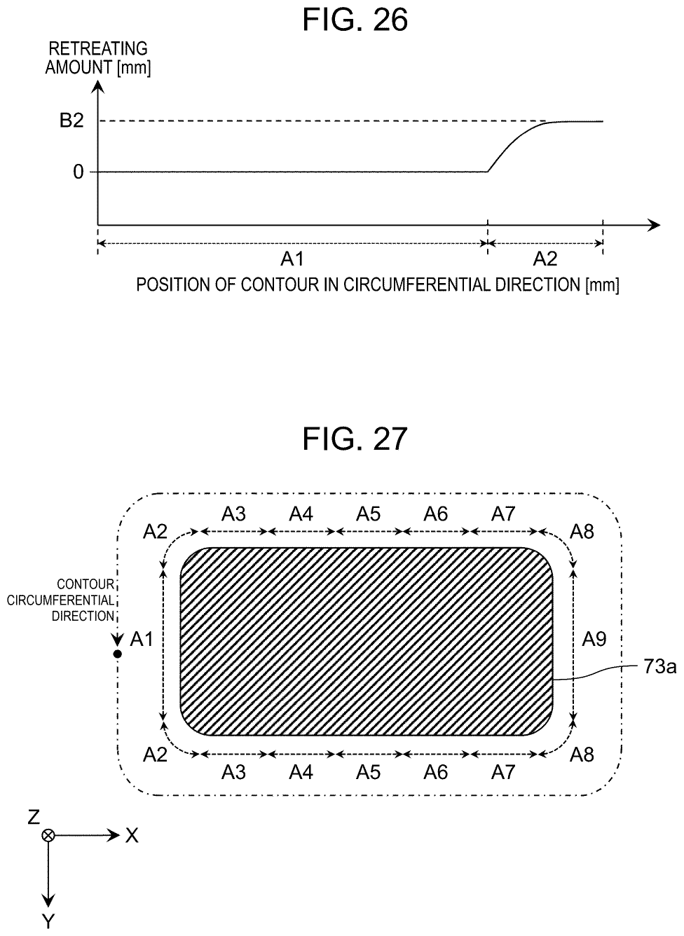

FIG. 26 is a diagram illustrating a retreating amount represented by the state data in the present modification. The distribution of the retreating amount in second zone A2 in FIG. 26 is obtained by giving distribution parameter E2 and retreating amount B2 to the function. Thereafter, similarly to the second exemplary embodiment, zone A2 is narrowed according to the retreating amount to obtain a synthesis waveform.

### Third Exemplary Embodiment

In the first exemplary embodiment, the example in which the initial values of retreating amounts B1 and B2 are both 0 mm has been described, but the initial value of the retreating amount of the tool of the present disclosure may have a different value for every zone. That is, the initial value of the retreating amount of the tool of the present disclosure may have a distribution corresponding to the position of the punched contour in the circumferential direction. Hereinafter, a third exemplary embodiment as an example having such a distribution will be described.

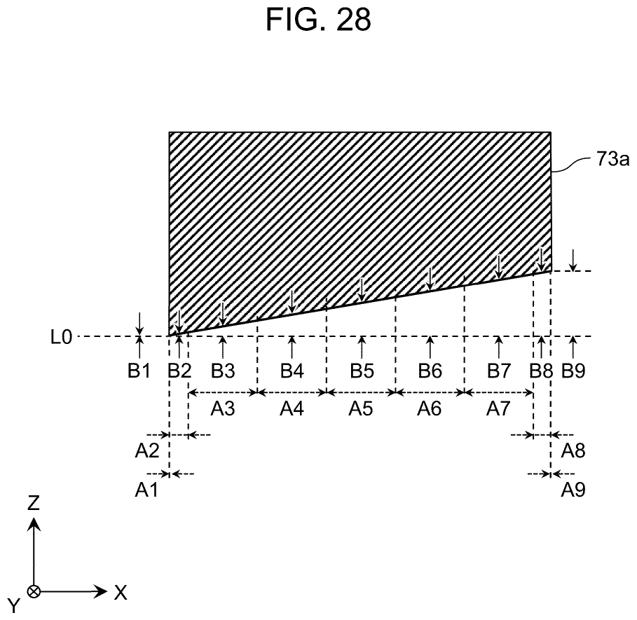

An example of a punch of pressing machine 50 according to the third exemplary embodiment is a so-called shear blade. FIG. 27 is a schematic sectional view of punch 73a of pressing machine 50 according to the third exemplary embodiment. FIG. 27 is a diagram of a section of punch 73a parallel to an XY plane as viewed in a positive direction of the Z-axis (that is, from below).

In the example of FIG. 27, the punched contour is divided into nine regions A1 to A9. Where to divide the punched contour is determined in advance according to the shape of the punched contour. In the example of FIG. 27, the punched contour is a rounded rectangle, and the punched contour is divided between each corner of the rounded rectangle and a straight line portion. Further, two straight line portions on a longitudinal side among four straight line portions (four sides) are each divided into five. In the example of FIG. 27, two portions that are line-symmetric with respect to a straight line passing through a center of the punched contour and parallel to the X-axis are denoted by the same reference marks.

In the example of FIG. 27, a 9 o'clock direction toward a paper surface is set as a criterion (start point) of the position of the punched contour, and a zone including the start point is set as first zone A1. First zone A1 is followed by second to ninth zones A2 to A9 counterclockwise in bottom view. The start point of first zone A1 when the punched contour is viewed counterclockwise in bottom view is used as the criterion of the position of the punched contour.

FIG. 28 is a sectional view of a section parallel to a ZX plane of punch 73a as viewed in a positive direction of the Y-axis (from a negative side of the Y-axis). Retreating amounts B1 to B9 illustrated in FIG. 28 represent the retreating amounts of zones A1 to A9 with predetermined Z position L0 as a criterion. In one example, assuming that initial values of retreating amounts B1 to B9 are B1i to B9i, B1i=0, and B1i<B2i<B3i<B4i<B5i<B6i<B7i<B8i<B9i.

As compared with the first exemplary embodiment, in the first exemplary embodiment, the initial value of the retreating amount of the punched contour of punch 73 has the same value (0 mm) over the overall region of the punched contour (punched at the same height on the Z-axis in design). In contrast, in the present exemplary embodiment, the initial value of the retreating amount of punch 73a has a gradient with respect to the Z-axis and has a distribution along the punched contour. Accordingly, in the present exemplary embodiment, the workpiece is continuously punched at different heights on the Z-axis in design, that is, the workpiece is subjected to shear punching.

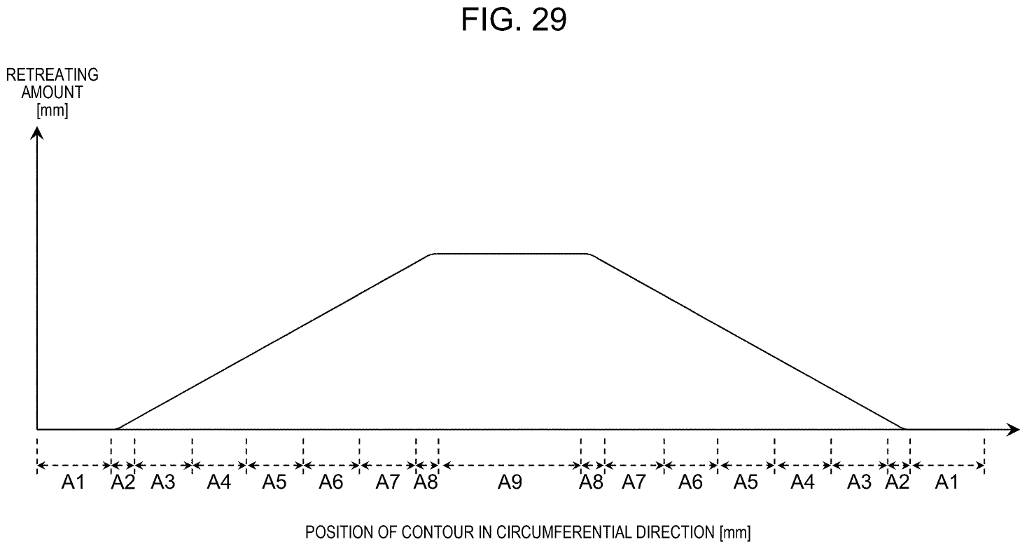

FIG. 29 is a graph representing a relationship between the actual retreating amount of the edge of punch 73a and the position of the punched contour in the circumferential direction. A horizontal axis of FIG. 29 indicates zones A1 to A9 corresponding to the positions of the punched contour in the circumferential direction.

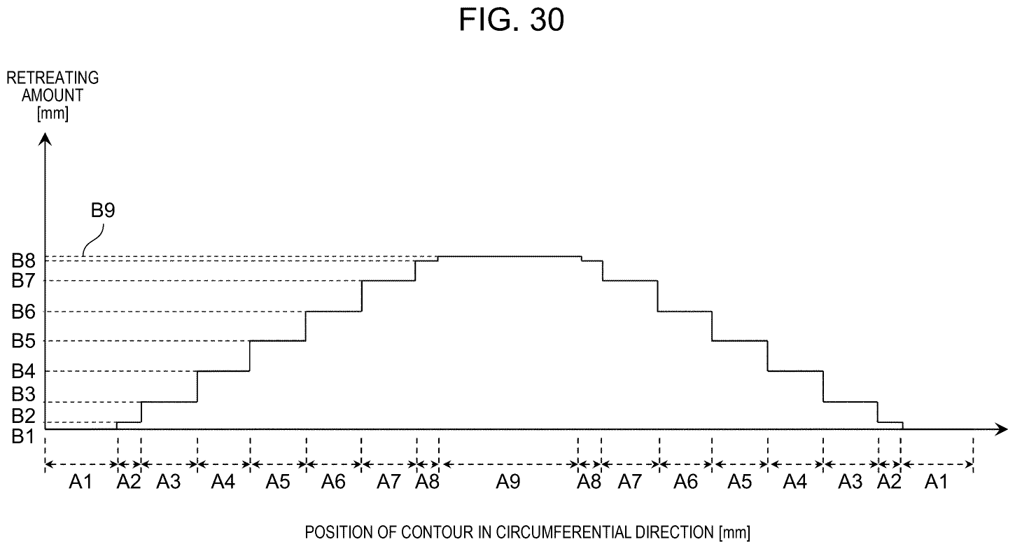

FIG. 30 illustrates data obtained by subdividing (discretizing) the actual retreating amount in FIG. 29. CPU 1 performs an arithmetic operation by using, for example, the data illustrated in FIG. 30. In the present exemplary embodiment, in each zone, the retreating amount is represented as a single parameter constituting a representative value of the actual retreating amount. In the example of FIG. 30, the retreating amount in first zone A1 is represented by B1 (=0), and the retreating amount in second zone A2 is represented by representative value B2 of the actual retreating amount. Similarly, the retreating amounts in third zone A3 to the ninth zone are represented by representative values B3 to B9 of the actual retreating amounts. The representative value is, for example, a maximum value, a median value, or an average value.

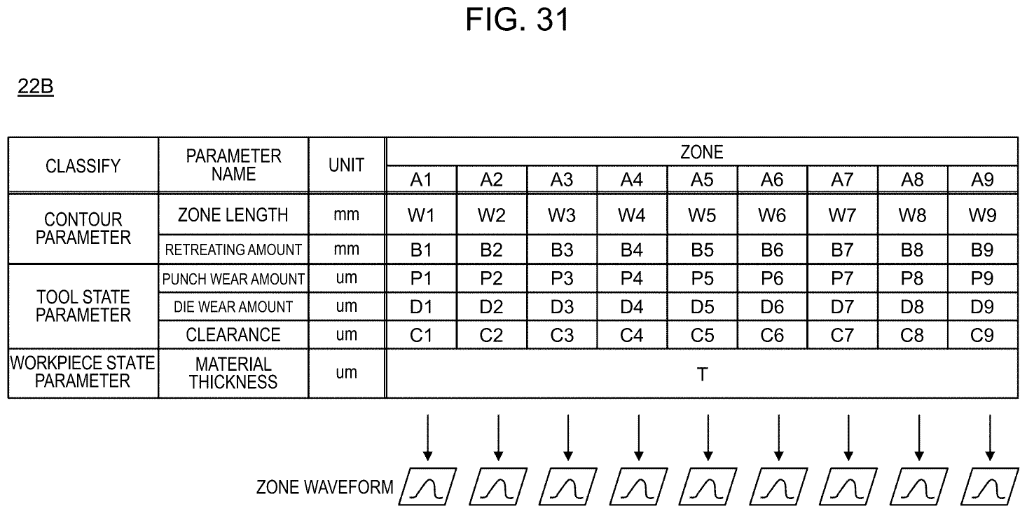

FIG. 31 is a table representing an example of state data 22B according to the present exemplary embodiment. State data 22B includes data regarding more zones than state data 22 according to the first exemplary embodiment illustrated in FIG. 9. Further, unlike the first exemplary embodiment, initial values B1i to B9i of retreating amounts B1 to B9 of the zones can be different from each other.

CPU 1 of machining-state-estimating device 100 uses state data 22B in the machining state estimation processing.

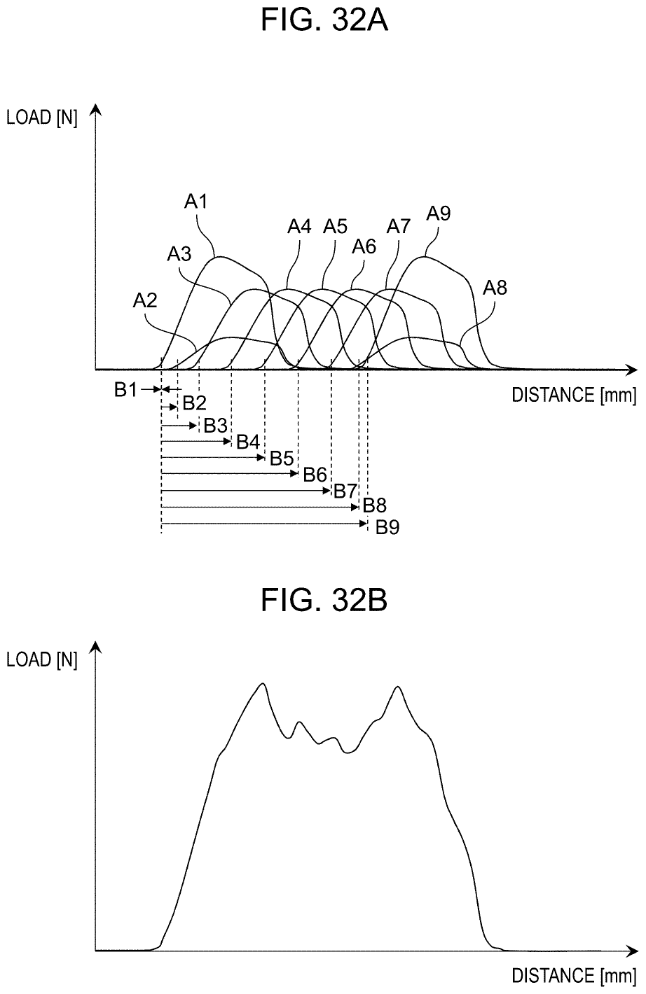

FIGS. 32A and 32B are graphs for explaining synthesis of waveforms in consideration of the retreating amount of punch 73a according to the present exemplary embodiment. While there are only two waveforms in FIG. 10A of the first exemplary embodiment, there are nine waveforms corresponding to zones A1 to A9 in FIG. 32A.

As illustrated in FIG. 32A, waveforms corresponding to zones A1 to A9 are shifted in the distance direction by retreating amounts B1 to B9 in step S5012 (see FIG. 14).

FIG. 32B is a schematic graph representing a reference waveform obtained by adding the nine waveforms in FIG. 32A. In S5013, CPU 1 generates the reference waveform of FIG. 32B indicating the load over the overall length of the punched contour by synthesizing the nine waveforms of FIG. 32A.

As described above, in the present exemplary embodiment, the contour parameter defines zone lengths W1 to W9 indicating lengths of the plurality of zones A1 to A9 representing the punched contour by pressing machine 50, and retreating amounts B1 to B9 indicating the dimensional change of the punched contour from the predetermined position in each zone. Initial values B1i to B9i of the estimated retreating amounts in the plurality of zones A1 to A9 are different for every zone.

Machining-state-estimating device 100 according to the present exemplary embodiment can estimate the machining state regardless of the presence or absence of chipping even though the tool is a shear blade. CPU 1 can generate the reference waveform having a higher matching degree with the measured waveform in consideration of the distribution of the retreating amount with respect to the position, and can estimate the machining state by pressing machine 50 more accurately than in the related art.

### Other Exemplary Embodiments

As described above, the exemplary embodiments have been described as examples of the technique in the present disclosure. However, the techniques in the present disclosure are not limited to the above exemplary embodiment and can also be applied to an exemplary embodiment in which modification, replacement, addition, removal, or the like is performed appropriately. In addition, the individual components described in the foregoing exemplary embodiment can be combined to provide a new exemplary embodiment. Accordingly, such other exemplary embodiments will be described below.

### First Another Exemplary Embodiment

For example, in the first exemplary embodiment, an example in which state data 22 includes the punch wear amount, the die wear amount, and the clearance as the tool state parameters (see FIG. 9) and CPU 1 estimates these three tool state parameters and the contour parameters has been described. However, the machining-state-estimating device according to the present disclosure may be configured to estimate at least one of the tool state parameters described above.

For example, even in the machining-state-estimating device configured to estimate only the clearance in the tool state, it is possible to estimate the clearances in the plurality of zones obtained by dividing the punched contour, and it is possible to estimate the clearances more accurately than in the related art. Even in a case where the first another exemplary embodiment is applied to the pressing machine having the shear blade as in the third exemplary embodiment, it is possible to estimate the clearance between the punch (shear blade) and the die.

### Second Another Exemplary Embodiment

In addition, in the above exemplary embodiment, an example in which CPU 1 executes reference waveform generation processing S501 corresponding to the state data has been described, but the present disclosure is not limited thereto. For example, reference waveforms corresponding to all combinations of zones A1 and A2 and the parameters may be calculated in advance by CPU 1, an external arithmetic operation device, or the like, and all the calculated reference waveforms may be stored in advance in storage device 2 in association with zones A1 and A2 and the combinations of the parameters.

In this case, instead of step S502 in FIG. 13, CPU 1 calculates the matching degree between the reference waveform stored in storage device 2 and the measured waveform acquired in step S1, and specifies the reference waveform having the maximum matching degree. Since zones A1 and A2 and the combinations of the parameters are associated with the specified reference waveform, each parameter such as the wear amount and the clearance of each zone can be estimated from the specified reference waveform.

In accordance with this configuration, since CPU 1 may not generate the plurality of reference waveforms in real time, a machining load and a processing time of CPU 1 can be reduced.

### Aspect Examples

Aspects of the present disclosure are illustrated below.

### <Aspect 1>

A machining-state-estimating device including
a storage device, and
a processor,
in which the storage device stores
criterion reference data corresponding to a parameter that defines a machining state of a pressing machine, and
zone shape information,
the zone shape information is information that defines a zone length and a retreating amount, the zone length indicating a length of each of at least one zone representing a punched contour by the pressing machine, the retreating amount indicating a dimensional change of the punched contour from a predetermined position in each of the at least one zone, and
the processor is configured to
acquire measurement data indicating a measurement result of a machining load of machining performed by the pressing machine,
generate comprehensive reference data regarding the machining load based on the criterion reference data and the zone shape information,
determine a similarity degree that is an index of a degree of similarity between the comprehensive reference data and the measurement data, and
estimate the machining state in each of the at least one zone based on the similarity degree determined.

### <Aspect 2>

The machining-state-estimating device according to Aspect 1,
in which the parameter defines a machining state per predetermined unit length of the punched contour,
the criterion reference data corresponds to the parameter per predetermined unit length of the punched contour, and
in the processing of generating the comprehensive reference data,
the processor is further configured to
generate zone data for each of the at least one zone regarding the machining load by multiplying the criterion reference data by a ratio of the zone length to the unit length for each of the at least one zone, and
generate the comprehensive reference data regarding the machining load over an overall length of the punched contour by synthesizing the zone data for each of the at least one zone.

### <Aspect 3>

The machining-state-estimating device according to Aspect 2,
in which the measurement data and the criterion reference data are data indicating a relationship between a machining load by the pressing machine and a moving distance of a punch with respect to a die of the pressing machine, and
in the synthesizing processing,
the processor is further configured to
add the retreating amount corresponding to each zone defined in the zone shape information to the zone data for each of the at least one zone, and synthesize the zone data for each of the at least one zone to which the retreating amount is added.

### <Aspect 4>

The machining-state-estimating device according to Aspect 2 or 3, in which the processor is further configured to generate the comprehensive reference data regarding the machining load over the overall length of the punched contour by calculating a sum of the zone data for each of the at least one zone.

### <Aspect 5>

The machining-state-estimating device according to any one of Aspects 1 to 4,
in which the processor is further configured to
search for comprehensive reference data having a maximum similarity degree with the measurement data, and
determine the parameter corresponding to the criterion reference data that is a basis of the searched comprehensive reference data and the zone shape information, as an estimated parameter representing a machining state at the time of measuring the measurement data.

### <Aspect 6>

The machining-state-estimating device according to Aspect 5, in which the processor is further configured to sequentially change the parameter within a predetermined range determined based on the estimated parameter already determined by the processor, and search for the comprehensive reference data having the maximum similarity degree with the measurement data.

### <Aspect 7>

The machining-state-estimating device according to Aspect 5 or 6, in which the estimated parameter includes an estimated zone length estimated as the zone length at the time of measuring the measurement data and an estimated retreating amount estimated as the retreating amount at a time of measuring the measurement data.

### <Aspect 8>

The machining-state-estimating device according to Aspect 7, in which the processor is further configured to set the estimated zone length and the estimated retreating amount to initial values when a signal indicating that a punch or a die of the pressing machine is replaced or polished is received.

### <Aspect 9>

The machining-state-estimating device according to Aspect 8,
in which the at least one zone comprises a plurality of zones, the zone shape information defines a zone length indicating a length of each of the plurality of zones representing the punched contour by the pressing machine and a retreating amount indicating a dimensional change of the punched contour from a predetermined position in each of the plurality of zones, and
initial values of the estimated retreating amounts in the plurality of zones are different for every zone.

### <Aspect 10>

The machining-state-estimating device according to any one of Aspects 1 to 9,
in which the pressing machine performs cycle machining, and
the processor is further configured to
acquire measurement data of each cycle of the pressing machine in time series,
in a case where a similarity degree between current measurement data acquired in a specific machining cycle and previous measurement data acquired in a machining cycle immediately before the specific machining cycle is more than a predetermined threshold value,
search for comprehensive reference data having a maximum similarity degree with the current measurement data, and
determine the zone shape information corresponding to the criterion reference data that is a basis of the searched comprehensive reference data, as an estimated parameter representing a machining state at the time of measuring the current measurement data.

### <Aspect 11>

The machining-state-estimating device according to Aspect 10,
in which the parameter includes a wear parameter that defines a degree of wear of a punch or a die of the pressing machine, and
in a case where the similarity degree between the current measurement data and the previous measurement data is less than or equal to the threshold value,
the processor is further configured to
search for the comprehensive reference data having the maximum similarity degree with the current measurement data, and
determine the wear parameter corresponding to the criterion reference data that is a basis of the searched comprehensive reference data, as an estimated parameter representing a machining state at the time of measuring the current measurement data.

### <Aspect 12>

The machining-state-estimating device according to Aspect 11, in which the processor is further configured to: set the wear parameter as the estimated parameter to an initial value in a case where the similarity degree between the current measurement data and the previous measurement data is more than the threshold value.

### <Aspect 13>

The machining-state-estimating device according to any one of Aspects 1 to 12, in which the retreating amount is constant in each zone.

### <Aspect 14>

The machining-state-estimating device according to any one of Aspects 1 to 12, wherein the retreating amount is changeable in accordance with a position of the zone length in a length direction in each zone.

### <Aspect 15>

A machining-state-estimating method including
acquiring, by a processor, measurement data indicating a measurement result of a machining load of machining performed by a pressing machine,
generating, by the processor, comprehensive reference data regarding the machining load based on criterion reference data and zone shape information, the criterion reference data corresponding to a parameter that defines a machining state of the pressing machine, the zone shape information defining a zone length and a retreating amount, the zone length indicating a length of each of at least one zone representing a punched contour by the pressing machine, the retreating amount indicating a dimensional change of the punched contour from a predetermined position in each of the at least one zone,
determining, by the processor, a similarity degree that is an index of a degree of similarity between the comprehensive reference data and the measurement data, and
estimating, by the processor, the machining state in each of the at least one zone based on the similarity degree determined.

According to the present disclosure, the machining state by the pressing machine can be estimated more accurately than in the related art.

### INDUSTRIAL APPLICABILITY

The present disclosure is applicable to pressing machines.

### REFERENCE MARKS IN THE DRAWINGS

2: storage device
3: input interface
4: output interface
11: load sensor
12: distance sensor
21: program
22: state data
23: waveform library
50: pressing machine
51: bolster
52: slide
61: die backing plate
62: die plate
63: die
71: punch backing plate
72: punch plate
73: punch
74: stripper plate
80: workpiece
100: machining-state-estimating device

1. A machining-state-estimating device comprising:
a storage device; and
a processor,
wherein the storage device stores
criterion reference data corresponding to a parameter that defines a machining state of a pressing machine, and
zone shape information,
the zone shape information is information that defines a zone length and a retreating amount, the zone length indicating a length of each of at least one zone representing a punched contour by the pressing machine, the retreating amount indicating a dimensional change of the punched contour from a predetermined position in each of the at least one zone, and
the processor is configured to
acquire measurement data indicating a measurement result of a machining load of machining performed by the pressing machine,
generate comprehensive reference data regarding the machining load based on the criterion reference data and the zone shape information,
determine a similarity degree that is an index of a degree of similarity between the comprehensive reference data and the measurement data, and
estimate the machining state in each of the at least one zone based on the similarity degree determined.

2. The machining-state-estimating device according to claim 1,
wherein the parameter defines a machining state per predetermined unit length of the punched contour,
the criterion reference data corresponds to the parameter per predetermined unit length of the punched contour, and
in the processing of generating the comprehensive reference data,
the processor is further configured to
generate zone data for each of the at least one zone regarding the machining load by multiplying the criterion reference data by a ratio of the zone length to the unit length for each of the at least one zone, and
generate the comprehensive reference data regarding the machining load over an overall length of the punched contour by synthesizing the zone data for each of the at least one zone.

3. The machining-state-estimating device according to claim 2,
wherein the measurement data and the criterion reference data are data indicating a relationship between a machining load by the pressing machine and a moving distance of a punch with respect to a die of the pressing machine, and
in the synthesizing processing,
the processor is further configured to
add the retreating amount corresponding to each zone defined in the zone shape information to the zone data for each of the at least one zone, and synthesize the zone data for each of the at least one zone to which the retreating amount is added.

4. The machining-state-estimating device according to claim 2, wherein the processor is further configured to generate the comprehensive reference data regarding the machining load over the overall length of the punched contour by calculating a sum of the zone data for each of the at least one zone.

5. The machining-state-estimating device according to claim 1,
wherein the processor is further configured to
search for comprehensive reference data having a maximum similarity degree with the measurement data, and
determine the parameter corresponding to the criterion reference data that is a basis of the searched comprehensive reference data and the zone shape information, as an estimated parameter representing a machining state at the time of measuring the measurement data.

6. The machining-state-estimating device according to claim 5, wherein the processor is further configured to sequentially change the parameter within a predetermined range determined based on the estimated parameter already determined by the processor, and search for the comprehensive reference data having the maximum similarity degree with the measurement data.

7. The machining-state-estimating device according to claim 5, wherein the estimated parameter includes an estimated zone length estimated as the zone length at the time of measuring the measurement data and an estimated retreating amount estimated as the retreating amount at a time of measuring the measurement data.

8. The machining-state-estimating device according to claim 7, wherein the processor is further configured to set the estimated zone length and the estimated retreating amount to initial values when a signal indicating that a punch or a die of the pressing machine is replaced or polished is received.

9. The machining-state-estimating device according to claim 8,
wherein the at least one zone comprises a plurality of zones,
the zone shape information defines a zone length indicating a length of each of the plurality of zones representing the punched contour by the pressing machine and a retreating amount indicating a dimensional change of the punched contour from a predetermined position in each of the plurality of zones, and
initial values of the estimated retreating amounts in the plurality of zones are different for each of the plurality of zones.

10. The machining-state-estimating device according to claim 1,
wherein the pressing machine performs cycle machining, and
the processor is further configured to
acquire measurement data of each cycle of the pressing machine in time series,
in a case where a similarity degree between current measurement data acquired in a specific machining cycle and previous measurement data acquired in a machining cycle immediately before the specific machining cycle is more than a predetermined threshold value,
search for comprehensive reference data having a maximum similarity degree with the current measurement data, and
determine the zone shape information corresponding to the criterion reference data that is a basis of the searched comprehensive reference data, as an estimated parameter representing a machining state at the time of measuring the current measurement data.

11. The machining-state-estimating device according to claim 10,
wherein the parameter includes a wear parameter that defines a degree of wear of a punch or a die of the pressing machine, and
in a case where the similarity degree between the current measurement data and the previous measurement data is less than or equal to the threshold value,
the processor is further configured to
search for the comprehensive reference data having the maximum similarity degree with the current measurement data, and
determine the wear parameter corresponding to the criterion reference data that is a basis of the searched comprehensive reference data, as an estimated parameter representing a machining state at the time of measuring the current measurement data.

12. The machining-state-estimating device according to claim 11, wherein the processor is further configured to set the wear parameter as the estimated parameter to an initial value in a case where the similarity degree between the current measurement data and the previous measurement data is more than the threshold value.

13. The machining-state-estimating device according to claim 1, wherein the retreating amount is constant in each zone.

14. The machining-state-estimating device according to claim 1, wherein the retreating amount is changeable in accordance with a position of the zone length in a length direction in each zone.

15. A machining-state-estimating method comprising:
acquiring, by a processor, measurement data indicating a measurement result of a machining load of machining performed by a pressing machine;
generating, by the processor, comprehensive reference data regarding the machining load based on criterion reference data and zone shape information, the criterion reference data corresponding to a parameter that defines a machining state of the pressing machine, the zone shape information defining a zone length and a retreating amount, the zone length indicating a length of each of at least one zone representing a punched contour by the pressing machine, the retreating amount indicating a dimensional change of the punched contour from a predetermined position in each of the at least one zone;
determining, by the processor, a similarity degree that is an index of a degree of similarity between the comprehensive reference data and the measurement data; and
estimating, by the processor, the machining state in each of the at least one zone based on the similarity degree determined.
